(19) United States
(12) Patent Application Publication
(10) Pub. No.: US 2016/0188757 A1
(43) Pub. Date: Jun. 30, 2016

(54) Sensor Deployment For Multi-modal Sensors

(71) Applicant: Invent.ly LLC, Woodside, CA (US)

(72) Inventors: Hector H. Gonzalez-Banos, Mountain View, CA (US); Asif Ghias, Novato, CA (US)

(21) Appl. No.: 14/746,677

(22) Filed: Jun. 22, 2015

Related U.S. Application Data
(63) Continuation-in-part of application No. 14/684,198, filed on Apr. 10, 2015.
Application No. 14/684,198 is a continuation-in-part of application No. 14/586,608, filed on Dec. 30, 2014.

(51) Int. Cl. G06F 17/50; G06F 17/11; H04L 29/08

(52) U.S. Cl. CPC G06F 17/5004; H04L 67/12; G06F 17/11

(57) ABSTRACT

An effective deployment strategy for multi-modal sensing stations is disclosed. Multi-modal sensing stations have one or more modes of operation, while the system and methods of the invention teach embodiments to deploy multi-modal sensors of varying capabilities in a workspace with real-world constraints. The solution computed by the instant invention includes location/placement and configuration/orientation of the sensing stations, as well as the switching sequences of their modes in order to provide desired coverage. The desired coverage is expressed by a performance measure, which can be a measure of time, or any other measure suited for a given application. Sensing stations are equipped with different types of sensors operating simultaneously to provide sensing, network or other types of coverages.

### RELATED APPLICATIONS

This application is a continuation-in-part of U.S. patent application Ser. No. 14/684,198 filed on Apr. 10, 2015, and is related to U.S. patent application Ser. No. 14/586,608 filed on Dec. 30, 2014, U.S. patent application Ser. No. 14/624,989 filed on Feb. 18, 2015 and U.S. patent application Ser. No. 14/640,951 filed on Mar. 6, 2015. These applications are incorporated herein in their entireties.

### FIELD OF THE INVENTION

This invention relates generally to the fields of computational geometry, combinatorics, set theory, linear programming, computer science, distributed/mobile sensor networks, wireless sensor networks, smart sensor networks and in particular to determining effective placement of different types of sensors in varied environments.

### BACKGROUND ART

There are a number of related disciplines with similar and sometimes conflated names such as wireless sensor networks, distributed sensor networks, mobile sensor networks, ubiquitous sensor networks, smart sensor networks that are concerned with effectively deploying various types of sensors in diverse environments for a large variety of industrial applications. It is no surprise that sensor deployment in such disciplines remains an active area of academic and industrial pursuit. With the ubiquity of sensors such as smart phones and other smart devices pervading through our daily lives, with concepts such as internet of things (IOT) maturing over the last decade, and with the interconnectedness of the world fast becoming a reality, it is no surprise that a large number of technology companies and academic institutions are spending a vast amount of resources in developing programs and products for deploying the ever increasing universe of sensors in the most effective manner possible.

In as far as devising strategies for deploying sensors, there are many schemes taught in the prior art. “A Randomized Art-Gallery Algorithm for Sensor Placement” by Hector Gonzalez-Banos et al. of Stanford University (2001) describes a placement strategy for computing a set of ‘good’ locations where visual sensing will be most effective. The sensor placement strategy relies on a randomized algorithm that solves a variant of the art-gallery problem known to those skilled in the art. The strategy finds a minimum set of guards inside a polygonal workspace from which the entire workspace boundary is visible. To better take into account the limitations of physical sensors, the algorithm computes a set of guards that satisfies incidence and range constraints.

“Coverage by directional sensors in randomly deployed wireless sensor networks” by Jing Ai et al. of Rensselaer Polytechnic Institute (2005) teaches a novel ‘coverage by directional sensor’ problem with tunable orientations on a set of discrete targets. It proposes a Maximum Coverage with Minimum Sensors (MCMS) problem in which coverage in terms of the number of targets to be covered is maximized whereas the number of sensors to be activated is minimized. The paper presents its exact Integer Linear Programming (ILP) formulation and an approximate (but computationally efficient) centralized greedy algorithm (CGA) solution. These centralized solutions are used as baselines for comparison. Then it provides a distributed greedy algorithm (DGA) solution. By incorporating a measure of the sensors residual energy into DGA, it further develops a Sensing Neighborhood Cooperative Sleeping (SNCS) protocol which performs adaptive scheduling on a larger time scale. Finally, it evaluates the properties of the proposed solutions and protocols in terms of providing coverage and maximizing network lifetime through extensive simulations.

“Selection and Orientation of Directional Sensors for Coverage Maximization” by Giordano Fusco et al. of Stony Brook University (2009) addresses the problem of selection and orientation of directional sensors with the objective of maximizing coverage area. Sensor nodes may be equipped with a ‘directional’ sensing device (such as a camera) which senses a physical phenomenon in a certain direction depending on the chosen orientation. The paper addresses the problem of selecting a minimum number of sensors and assigning orientations such that the given area (or set of target points) is k-covered (i.e., each point is covered k times).

The above problem is NP-complete, and even NP-hard to approximate. The paper presents a simple greedy algorithm that delivers a solution that k-covers at least half of the target points using at most M log(k|C|) sensors, where |C| is the maximum number of target points covered by a sensor and M is the minimum number of sensors required to k-cover all the given points.

In “Efficient Sensor Placement for Surveillance Problems”, Agarwal et al. of Duke University (2009) studies the problem of covering by sensors of a two-dimensional spatial region P that is cluttered with occluders. A sensor placed at a location p covers a point x in P if x lies within sensing radius r from p and x is visible from p, i.e., the segment px does not intersect any occluder. The goal is to compute a placement of the minimum number of sensors that cover P. It proposes a landmark-based approach for covering P.

In “On Sensor Placement for Directional Wireless Sensor Networks”, Osais of Carleton University, Ottawa (2009) discusses a directional sensor network that is formed by directional sensors which may be oriented toward different directions. The sensing region of a directional sensor can be viewed as a sector in a two-dimensional plane. Therefore, a directional sensor can only choose one sector (or direction) at any time instant. They discuss the placement of such directional sensors as a critical task in the planning of directional sensor networks. They also present an integer linear programming model whose goal is to minimize the number of directional sensors that need to be deployed to monitor a set of discrete targets in a sensor field. Numerical results demonstrate the viability and effectiveness of the model.

In a paper titled “Placement and Orientation of Rotating Directional Sensors”, Giordano Fusco et al. of Stony Brook University (2010) addresses several problems that arise in the context of rotating directional sensors. Rotating directional sensors (RDS) have a “directional” coverage region that “rotates” at a certain speed. For RDS with fixed given locations, they address three problems with the objective to minimize different functions of the dark time (i.e., uncovered time) of the given points in the area. In addition, they also consider the problem of placement and orientation of the minimum number of given RDS, so as to reduce the dark time of all given points to zero.

In general, the problem of sensor placement in an occluded space is well studied. Such a system 10 of prior art is illustrated in FIG. 1. System 10 comprises of several obstructions 14. Specifically, there are 6 obstructions as illustrated in FIG. 1. An effective sensor placement strategy addresses the problem of finding the optimal (minimum) number of locations where sensors, for example cameras, that need to be placed such that any part of a region of interest of system 10 is visible to at least one sensor. Such a solution in the literature is sometimes referred to as a 1-guard solution.

The problem is oftentimes described in the context of a workspace or a region of interest where sensors are placed. Such a system 20 of prior art is illustrated in FIG. 2 comprising the elements of FIG. 1 but with a well-defined workspace 12 that contains obstructions 14. Note we have labeled only two such obstructions in FIG. 2 for clarity. An effective sensor placement strategy addresses the problem of finding the optimal (minimum) number of locations where sensors, for example cameras, can be placed in workspace 12 such that any part of the entire workspace is visible to at least one sensor. As mentioned, such a solution in the literature is sometimes referred to as a 1-guard solution.

A system 30 of prior art is illustrated in FIG. 3, in which sensor 16 is placed in workspace 12 as shown such that areas within workspace 12 unaffected by obstructions 14, as depicted by the hatch pattern, are visible to sensor 16 (assuming a straight line of sight visibility model for sensor 16). Note, that no other range or direction constraint is placed on the visibility model of sensor 16 as depicted in FIG. 3. Several prior art teachings describe strategies for placement of such sensors inside workspace 12 such that any part of workspace 12 is visible to at least one sensor 16 despite obstructions 14 in workspace 12.

A shortcoming of prior art teachings is that they do not provide a strategy for sensor deployment that includes multiple sensors or sensing stations, each with different sensing/visibility models and constraints. Further, the prior art assumes a simple sensing model for the sensors that is based on an individual type of sensor, rather than a composite visibility model that is based on a collection of various types of sensors on a given sensing station. A further shortcoming of the prior art is that it generally conflates the notions of ‘sensing coverage’ that is concerned with sensing a set of target sites or other sensors or sensed stations in a workspace, and ‘network coverage’ that is concerned with connecting or communicating with the target sites or other sensors or sensed stations in the workspace.

The prior art teachings are also silent about providing coverage using sensors that are multi-modal or have more than one mode of operation. Such sensors are sometimes referred to as smart, adaptive, phased, switched or multi-modal sensors and have the desired capability to have their modes of operation configured/activated at run-time. Several rotational or motion sensors also fall into this category.

### OBJECTS OF THE INVENTION

In view of the shortcomings of the prior art, it is an object of the present invention to teach a more effective deployment strategy for sensors than is available through the teachings of the prior art.

It is further an object of the invention to allow sensing stations having multiple types of sensors, each with its own sensing model and constraints.

It is further an object of the invention to allow sensing stations to have multiple modes of sensing.

It is further an object of the invention to provide coverage using multi-modal sensing stations according to a variety of performance measures.

It is further an object of the invention to incorporate sensing coverage and network coverage simultaneously in the deployment of sensors as taught by the present invention.

### SUMMARY OF THE INVENTION

The objects and advantages of the invention are accrued by a system and methods for determining a set of placement sites from a set of candidate sites. The candidate sites refer to the potential locations and other configuration information of sensing stations, while the placement sites determined or computed by the system comprise those candidate sites where the sensing stations should be placed or deployed in order to provide coverage according to the invention. The system and methods of the invention further determine the order or sequence of activation of various modes of operation i.e. switching sequence of the sensing stations in order to provide the desired coverage. The system further comprises a target/ground set corresponding to each stage of the switching sequence, each target/ground set further comprising target sites. The target sites refer to the potential locations and configurations of sensed stations that are desired to be sensed or communicated with for the desired coverage. The system further comprises zero or more obstructions that would obstruct the sensing or communicating with, of the sensed stations by the sensing stations. Preferably the system operates in a workspace, which can be either continuous or discretized/sampled.

Each sensing station has one or more sensing regions around it, each such sensing region likely but not necessarily existing due to individual sensors on the sensing station. The sensing region is defined as the set of all sites that are able to be sensed or communicated with if there are sensed stations placed at those sites, by that sensing station, despite the obstructions. The sensing region is further constrained by a sensing range and a sensing orientation of the corresponding sensing station. Subsequently, a composite sensing region for each sensing station is defined as the collection of one or more individual sensing regions of the sensing station. Each sensing station also has a mode of operation, and its composite sensing region is correspondent to the mode of its operation.

The composite sensing region, as a collection of individual sensing regions, is determined by the mode the sensing station is in, and the mode is further established in according with the switching sequence of the sensing station. The mode thus governs the sensing regions of the sensing station, and in other words determines the beam-pattern(s), sometimes also referred to as simply beam(s), radiated by the sensing station. Preferably, the mode is further governed by operational parameters or simply parameters, such as the field-strength of its radiated beam-pattern, the heading or direction of the beam-pattern(s), the geometry/shape and other related configuration aspects of the beam-pattern(s). Other parameters governing the mode include, but are not limited to gain, geometry, frequency, signal-phase (i.e. the phase or temporal shift applied to the signal), power (drawn at input by the sensor), polarization (of the beam), Time-of-Flight (ToF) imaging, phase-noise and impedance. The beam-pattern(s) ultimately define the sensing regions of the sensing station. Oftentimes, the terms sensing region and beam-pattern are used interchangeably in this disclosure for convenience.

The coverage solution thus computed by the system and methods of the invention, provide the location and configuration/orientation of the sensing stations, as well as the switching sequence in which the various modes of each sensing stations should be activated or switched in order to provide the desired coverage. Such a solution is computed by the instant invention on a ‘best-effort’ basis. The desired coverage is determined by a performance measure which can be chosen according to the needs of a given application of the invention. In one embodiment, the switching sequence is predetermined i.e. it cannot be reconfigured at run-time. The solution thus computed by the invention comprises of location/placement and orientation/configuration of the sensing stations only, while the switching order of the various modes of the sensing station stays fixed.

The performance measure of the desired coverage is preferably a measure of time. In a related embodiment, the performance measure is chosen such that each target site is covered for at least one instant of time. In a variation of this embodiment, the performance measure is chosen such that each target is covered at least a given fraction of the time. In yet another related embodiment, the performance measure is chosen such that at most a given fraction of target sites remain uncovered. In still another embodiment, the performance measure is chosen such that all target sits are covered at all the times.

The various modes of the sensing stations preferably change synchronously with respect to one another. In another preferred variation, at each given stage or time period of the switching sequence, each sensing station is in the same mode of operation. In a related variation, each sensing station is in the same mode, but the parameters of the modes are allowed to differ from one another. In another preferred embodiment, the collection of individual sensing regions of a sensing station, called the composite sensing region, is taken to be a union of the individual sensing regions. Alternatively, the composite sensing region is taken to be an intersection of the individual sensing regions. Still in another embodiment, the composite sensing region is taken to be based on a generic set operation or some other generic mathematical operation of the individual sensing regions of the sensing station.

Preferably, the target sites are merely the locations of interest that need to be observed. Hence, there is no sensor or device present at the location that needs to be observed in such a preferred embodiment. Instead the location or site itself is what is being sensed or observed by the sensing station. In another preferred embodiment, the candidate site comprises the location of the site in two, three or higher dimensions, and the angle(s) of orientation of the sensing station placed at that candidate site in two, three or higher dimensional space respectively. Preferably, the angle(s) of orientation is/are unconstrained or omni-directional, so that the candidate site merely refers to the location of the placement of the sensing station. Similarly, in another preferred embodiment, the target site comprises the location of the site in two, three or higher dimensions, and the angle(s) of orientation of the sensed station placed at that target site in two, three or higher dimensions respectively. Preferably, the angle(s) of orientation is/are unconstrained or omni-directional, so that the target site merely refers to the location of the placement of the sensed station.

In another embodiment, each sensed station also has one or more sensed regions around it, likely but not necessarily, as a result of the individual sensors present on the sensed station. A sensed region of a sensed station at a target site is defined as the set of all sites around that sensed station that if overlapping with the sensing region of a sensing station at a candidate site will result in that sensed station being sensed or communicated with, by that sensing station. Preferably, the sensing region of a sensing station at a candidate site and a sensed region of a sensed station at a target site are defined such that the sensing station can sense or communicate with the sensed station only if the sensed station is in the sensing region of the sensing station and the sensing station is in the sensed region of the sensed station.

Preferably, the sensed region is further constrained by a sensed range and a sensed orientation of the sensed station. Preferably, there is a composite sensed region around each sensed station that is a collection of the individual sensed regions around the sensed station. In the preferred embodiment, the collection of individual sensed regions of a sensed station, called the composite sensed region, is taken to be a union of the individual sensed regions. Alternatively, the composite sensed region is taken to be an intersection of the individual sensed regions. Still in another embodiment, the composite sensed region is taken to be based on a generic set or mathematical operation of the individual sensed regions of the sensed station.

Preferably, the workspace of operation of the system of the instant invention is sampled or discretized. Alternatively, the workspace is continuous. Preferably, the candidate sites determined by the apparatus and methods of the invention overlap with the target sites. Alternatively, the candidate sites determined by the invention do not overlap with the target sites. In a related embodiment, the union of all target sites represents the entirety of the workspace. In another advantageous embodiment there is another constraint placed on the apparatus and methods of the invention that requires the placement sites to have locations chosen from a set of predetermined locations in a workspace. Similarly, in another embodiment the constraint placed is such that the placement sites can only be chosen from a predetermined region in the workspace. Still in another preferred embodiment, there is a predetermined number of a certain type of sensors available.

In a highly preferred embodiment, the coverage solution determined by the invention is based on the popular Greedy algorithm. Preferably the coverage solution is derived in polynomial time. In another embodiment, the sensing station is a camera and the target sites are in a surveillance space that needs to be monitored. In another preferred embodiment, the sensing stations and the sensed stations are wireless sensors operating substantially in the popular 60 GHz frequency range. In still another preferred embodiment, the targets sites are objects of interest. In another preferred embodiment, the sensing stations are people or objects, and the candidate and target sites are the coordinates of location in a geographical place or terrain.

Clearly, the system and methods of the invention find many advantageous embodiments. The details of the invention, including its preferred embodiments, are presented in the below detailed description with reference to the appended drawing figures.

### BRIEF DESCRIPTION OF THE DRAWING FIGURES

FIG. 1 is a sensor deployment system of the prior art for deployment of sensors in an environment with obstacles.

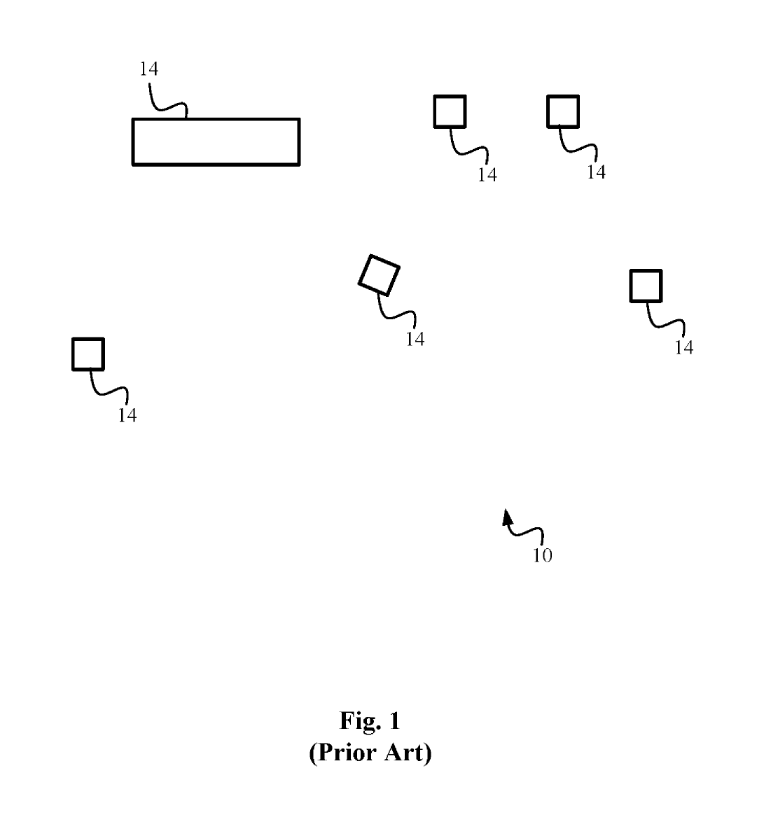

FIG. 2 is a variation of the prior art system of FIG. 1 having a well-defined workspace.

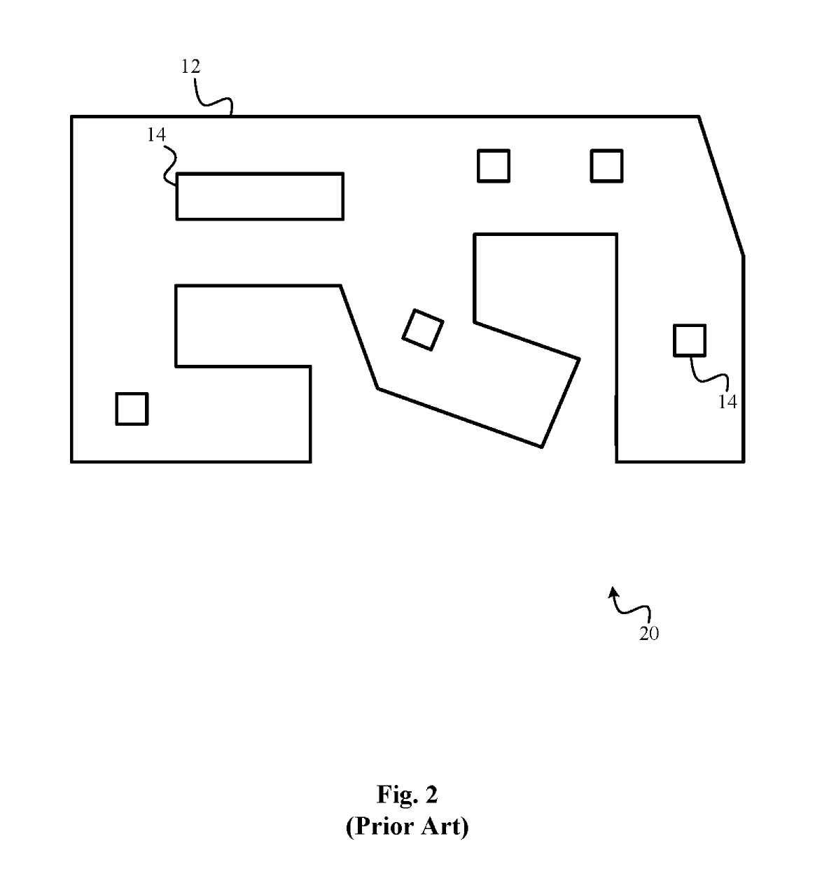

FIG. 3 is the sensor deployment system of FIG. 2 containing a sensor without range or directional constraints.

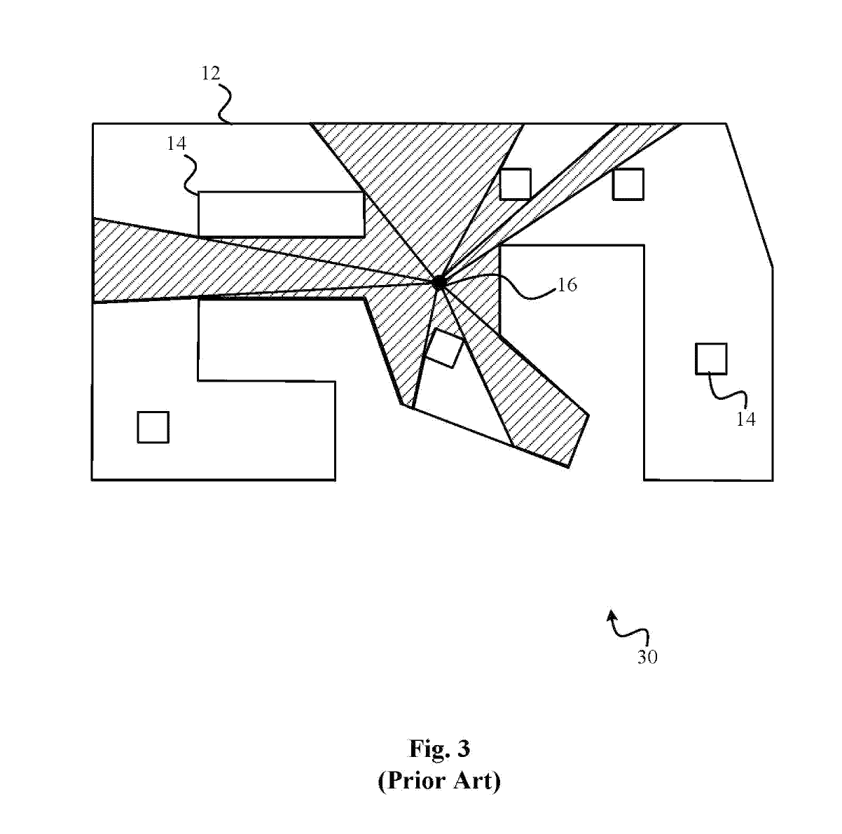

FIG. 4 is a sensor deployment system according to the present invention for deploying a variety of sensors in a workspace with obstructions.

FIG. 5 is a multi-modal sensor deployment system of the instant invention, comprising a phased-array sensing station.

FIG. 6 is another example of a multi-modal sensing station according to the instant invention.

FIG. 7 shows several target sites that are desired to be covered in the variation shown in FIG. 6.

FIG. 8 shows a solution computed for the embodiment of FIG. 6 utilizing one of the algorithms of the instant invention.

FIG. 9 shows several unevenly distributed target sites in the variation shown in FIG. 6.

FIG. 10 shows a solution computed for the sensor of FIG. 6 and target sites of FIG. 9, utilizing a generalized algorithm of the instant invention.

FIG. 11 shows another variation of a multi-modal sensor deployment system of the instant invention, comprising a rotational sensor.

FIG. 12 shows the target sites and the solution computed for the embodiment of FIG. 11 according to the generalized algorithm of the instant invention.

FIG. 13 shows yet another multi-modal sensor deployment system of the instant invention comprising a sensor having irregular modes or sensing regions.

FIG. 14A-D shows the target sites and the various stages of the switching sequence of the computed solution for an embodiment utilizing sensing stations from FIG. 6 and FIG. 13.

FIG. 15 shows a discrete sampling of the workspace of FIG. 4.

FIG. 16 shows a sensor deployment system of the current invention where discretely sampled target sites are non-overlapping with the candidate sites.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality.

The figures depict embodiments of the present invention for purposes of illustration only. One skilled in the art will readily recognize from the following description that alternative embodiments of the structures and methods illustrated herein may be employed without departing from the principles of the invention described herein.

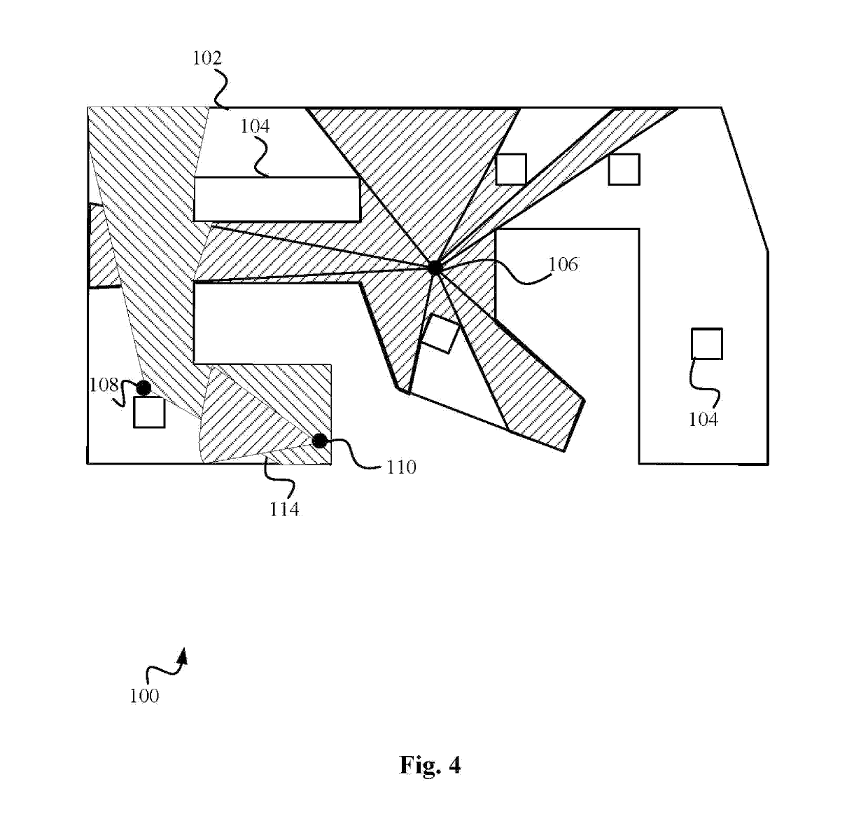

The present invention will be best understood by first reviewing the sensor deployment system 100 illustrated in FIG. 4. FIG. 4 illustrates a workspace 102 in two dimensions that has a number of obstructions 104 as indicated. FIG. 4 and associated explanation below, as well as other embodiments taught later throughout this specification will be explained taking advantage of the clarity of two dimensional illustrations where possible. Those skilled in the art will readily recognize that the below teachings are directly applicable to any higher dimensional environment and the reference to two dimensional illustrations are for convenience only. Wherever possible, three dimensional illustrations may also be referenced in the below teachings for completeness.

Workspace 102 has six obstructions 104 as indicated in FIG. 4. Before proceeding further, let us define the notion of a workspace. A workspace is any imaginary or real region of interest where we are interested in working by activities including but not limited to, such as performing observations and/or placing sensors. In the explanation of subsequent embodiments, we may define a workspace having a well-defined boundary, e.g. workspace 102 of FIG. 4, however such a definition is an optional formality, and the benefits of the invention can be accrued in any location, space or volume, without having a well-defined and formalized boundary of a workspace.

FIG. 4 also illustrates a sensing station 106 that is omni-directional, that is, it has no constraint on its orientation. Generally available radio receivers are an example of such omni-directional sensing stations or sensors. Furthermore, sensing station 106 does not have any range constraint within the context of workspace 102. In other words, the range of sensing station 106 is infinite compared to the dimensions of workspace 102. It will be obvious to those skilled in the art, that any real receiver will have a finite range of reception or a receiving range. However, for the purpose of explaining the current embodiment in regards to sensing station 106, we will assume that such range of sensing station 106 is substantially more than the dimensions of workspace 102.

Workspace 102 is assumed to comprise of a collection of sites embodied by its interior, excluding obstructions 104. In other words, obstructions 104 exist to limit or obstruct the sensing capabilities of sensing stations. More formally, any impediment in the segment connecting a point a to b such that b cannot be visible to, sensed by, communicated with, monitored, surveilled or observed by a sensing station at a, and vice versa, is regarded as an obstacle or obstruction. Generally, a site will represent a physical location in the workspace and additional configuration information of the sensor present at that location.

The terms, a site, a point or location may be used interchangeably in the following explanation, and distinction between them will be drawn where needed and appropriate. Also, in this specification, as appropriate, the term sensor may be used to refer to a sensing station as well as a sensed station, when the distinction between the two is obvious from the context. Furthermore, we may use the terms sensing station and guard interchangeably as the latter is sometimes used in the art. Further still, we may use the terms sensed stations and target sites interchangeably in this specification with the knowledge that in many preferred embodiments of the invention a sensed station merely represents a site or location of interest in the workspace, and draw distinction between the terms as necessary.

Sensor deployment system 100 of FIG. 4 also has a sensor 108 that has no sensing range constraint, but has sensing orientation or a directional constraint. Further explained, the reception range of sensing station 108 is larger than the dimensions of workspace 102 and its orientation constraint is shown by the direction of its hatched cone of reception pointing north-east as indicated in FIG. 4. Such a reception cone is typical of dish antennas, for example. Finally, system 100 also shows a sensing station 110 that has both a sensing range constraint and a sensing orientation constraint. The sensing range constraint of sensing station 110 is indicated by the finite radius 114 of the cone of reception of sensing station 110, and its directional constraint is shown by the direction of the cone pointing in the west-ward direction shown in FIG. 4. According to the invention, target sites are the potential locations of sensed stations. A set of target sites in a workspace represents the locations of interest that are required to be observed. Sensed stations are potentially placed/located/situated at the target sites that can be sensed or communicated with, by sensing stations placed at candidate sites. Alternatively stated, sensed stations potentially occupy the target sites that are required to be monitored/observed.

In a highly preferred set of embodiments, the sensed stations merely represent the sites or locations in a workspace. To keep clarity, and to avoid redundancy in this explanation, when referring to these embodiments we may either refer to sensing stations as sensing/monitoring/observing/communicating with, the target sites, locations, or regions of the workspace, or alternatively we may simply refer to sensing stations as sensing/communicating with, the sensed stations, with the understanding that no sensed stations may actually be present at the target sites, locations or regions of the workspace. One, such preferred embodiment as illustrated in FIG. 4, shows that the target sites comprise the entirety of the interior of workspace 102, notwithstanding obstructions 104. In other words, there is no presumption of sensed stations present in workspace 102, and the objective is to monitor the target sites comprising the interior of workspace 102. The set of such target sites is represented by set X, oftentimes referred to as the ground set. In other words, ground set X represents the set of all those sites or points in workspace 102 (not including obstructions 104), that are required to be observed by sensing stations 106, 108 and 110.

A workspace whose entirety is to be observed without further qualification, is also referred to as a continuous workspace. However, as will be further taught below, many practical applications find it useful to sample the workspace into a discrete set of target points/sites—a process called discretization, and resulting in a discretized workspace. Hence generally when we refer to target sites in the workspace, that implies a discretization of the workspace. Note that the discretization can be extremely dense as well as sparse, as per the needs of an application. As a result, and as is customary in many texts, when we simply say that the entirety of a region or workspace is to be observed, we are making a tacit assumption that there is a dense discretization of that region or workspace, containing a large number of discrete target sites that are required to be observed. An analogous explanation also applies to candidate sites and placement sites.

According to the apparatus and methods of the main embodiments of the present invention, a sensing region exists around each sensing station when that sensing station is at a given site, called a candidate site. A candidate site would generally comprise the location information of the sensing station, the type of sensing station (106, 108 or 110) and any other ancillary information that may be needed to be associated with the candidate site. Such ancillary information may include, but is not limited to, the configuration of the sensor including its orientation, its sensing region (as will be taught below), and its any other capabilities or constraints, etc. Note, the invention refers to all such potential sites where a sensing station can be placed as candidate sites, and it refers to that subset of candidate sites where the sensing stations should be placed or deployed in order to ensure coverage according to the instant invention, as placement sites. In other words, the set of placement sites or simply placement sites refers to the ‘computed solution’ of the sensor deployment strategy as offered by the instant invention.

The location information of a candidate site may include the two-dimensional or three-dimensional coordinates in a two-dimensional or three-dimensional Euclidean space of the system. The orientation information of a sensing station may include its three axes of orientation with respect to a given coordinate system. The orientation may be represented by rotation matrices Rₓ(∝) for rotation by angle ∝ around x-axis, R_{y}(β) for rotation by angle β around y-axis and R_{z}(γ) for rotation by angle γ around z-axis, or by Euler angles or still by any other rotation convention familiar to people of skill.

Further, a skilled artisan will understand that rigid body rotations are conveniently described by three Euler angles (φ, θ, ψ). Specifically, Euler angles (φ, θ, ψ) describe how body axes (X_{b}, Y_{b}, Z_{b}) originally aligned with the axes (X, Y, Z) of a coordinate system transform after three rotations are applied in a pre-established order. The magnitudes of Euler angles (φ, θ, ψ) define rotation of body axes (X_{b}, Y_{b}, Z_{b}) in the above-defined order. A skilled artisan will also be well versed in alternative rotation conventions and descriptions thereof. These will not be delved into further detail in this specification. For clarity and ease of explanation in the below teachings, we will sometimes use the angle θ with respect to a known axis in two-dimensional space to indicate the orientation of a sensor.

Preferably the location information of a candidate site is represented by (x, y, z) coordinates in three-dimensional Euclidean space, and the orientation of the sensing station is omni-directional, that is, it is unconstrained. Preferably the location information of a candidate site is represented by just (x,y) coordinates in two-dimensional Euclidean space, and the orientation of the sensing station with respect to an axis of the two-dimensional coordinate system is represented by the angle θ. Preferably the location information of a candidate site is represented by (x,y) in two-dimensional Euclidean space, and the orientation of the sensing station is omni-directional, that is, it is unconstrained.

Note that when we refer to an unconstrained orientation of a sensing station or characterize its orientation to be omni-directional above, by that we simply mean that the sensing station is able to sense in all directions, irrespective of where it is ‘facing’. In other words, there is no front or back, or top or down, of the sensor. As will be apparent to those skilled in the art, a variety of such omni-directional sensors are commonplace in the industry, such as a 360° omni-directional or panoramic camera or an analogous microphone.

Similar to a candidate site, the location information of a target site may include its two-dimensional or three-dimensional coordinates in two-dimensional or three-dimensional Euclidean space of the system. The orientation information of a sensed station may include its three axes of orientation with respect to a given coordinate system. The orientation may be represented by rotation matrices Rₓ(∝) for rotation by angle ∝ around x-axis, R_{y}(β) for rotation by angle β around y-axis, R_{z}(γ) for rotation by angle γ around z-axis, or by Euler angles or still by any other rotation convention familiar to people of skill.

Preferably the location information of a target site is represented by (x, y, z) coordinates in three-dimensional Euclidean space, and the orientation of the sensed station is omni-directional, that is, it is unconstrained. Preferably the location information of a target site is represented just (x,y) coordinates in two-dimensional Euclidean space, and the orientation of the sensed station with respect to an axis of the two-dimensional coordinate system is represented by the angle θ. Preferably the location information of a target site is represented by (x,y) coordinates in two-dimensional Euclidean space, and the orientation of the sensed station is omni-directional, that is, it is unconstrained.

Similar to a sensing station, when we refer to an unconstrained orientation of a sensed station or characterize its orientation to be omni-directional above, that simply means that the sensed station is able to be sensed from all directions, irrespective of where it is ‘facing’. In other words, there is no front or back, or top or down, of the sensor. Again, as will be apparent to those skilled in the art, a variety of such omni-directional sensors are commonplace in the industry, such as an omni-directional radio transmitter with a dipole antenna.

The reader is informed that while the above explanation of the location coordinates of candidate and target sites, and sensing and sensed stations, as well as their orientations, leverages the familiar two-dimensional and three-dimensional Euclidean space, the principles of the instant invention apply equally to any higher-dimensional i.e. an n-dimensional space, where n is a whole number greater than 1. While the below teachings, illustrations and examples take advantage of the clarity of two-dimensions, that is for convenience only, and the reader is advised of the broader applicability of the teachings to three-dimensional and n-dimensional environments.

Referring to FIG. 4, according to the invention, a sensing region or a visibility region, of a sensing station at a given candidate site represents the collection of sites or locations that can be sensed by that sensing station when that sensing station is placed at that candidate site. If one or more of the above sites are occupied by sensed stations, then a sensing region or a visibility region, of a sensing station at a given candidate site represents the collection of those sites or locations which the sensing station can sense, or communicate with sensed stations if they are present at any of those sites, or sense the presence of sensed stations if they are present at any of those sites. More rigorously, a sensing region v(p) around a sensing station located at a candidate site p represents the collection of target sites b where a site bεv(p) if a sensed station at site b is able to be sensed or communicated with, by the sensing station despite obstructions 104 in FIG. 4. Using the notational convenience of set theory, we succinctly state that v(p)∩b≠Ø, for ∀b.

Still differently put, sensing region v(p) represents the region around a candidate site p in which a sensing station can sense another sensed station. In case of the preferred embodiment depicted in FIG. 4 where sensed stations merely represent the sites/points or locations of interest that are required to be observed in workspace 102, sensing region v(p) of a sensing station at a candidate site p simply represents the region around a candidate site p which the sensing station can sense or monitor. Specifically, referring to FIG. 4, sensing region v(p) of sensing station 106 is shown by the star-shaped polygon, or omni-directional hatched cones shown as extending from sensing station 106 in all directions. Sensing region v(p) of sensor 108 is shown by the single, directed hatched cone extending in the upper-right or north-east direction from sensing station 108 and sensing region v(p) of sensor 110 is represented by a single hatched cone with length or radius 114 extending left-ward or west-ward from sensing station 110.

The invention further defines a sensing range and a sensing orientation as constraints that may apply to a given sensing station. These constraints are typical of the real world sensors available in the industry. For example, while a standard radio receiver can be an omni-directional sensing station with no sensing orientation or directional constraint, in the form of a parabolic dish however, a radio receiver can also be a directional antenna. In the example illustrated in FIG. 4 containing system 100 where target sites are preferably locations or points within workspace 102, omni-directional sensing stations 106 can be a 360° omni-directional panoramic camera, while sensing station 108 can be a standard directional camera such as the one generally used in Closed-Circuit Television (CCTV) or video surveillance, and sensing station 110 can be a directional infra-red motion sensor with a limited range, such as the one used in home alarm systems.

The invention further allows a given sensing station to have multiple sensors on it, each with its own sensing region defined above. Thus according to the foregoing formal definition of a sensing region, a sensing region vₖ(p) around a sensing station located at a candidate site p represents the collection of target sites b where bεvₖ(p) if a sensed station at site b is able to be sensed or communicated with by sensor k of the sensing station despite obstructions 104. Differently put, a sensing region corresponding to a given sensor on a sensing station when that sensing station is placed at a candidate site represents the collection of sites or locations that can sensed by that sensor of the sensing station. Of course it is conceivable within the scope of the present invention to have a single complex sensor on a sensing station that has multiple sensing capabilities with multiple sensing regions according to the above definition.

Following directly from above, according to the present invention, a composite sensing region around a sensing station is defined as the collection of the individual sensing regions around that sensing station. As mentioned above, most likely but not necessarily, these individual sensing stations may be due to individual sensors on the sensing station. More rigorously, a composite sensing region v(p) of a sensing station is defined as the collection of up to k sensing regions vₖ(p) when the sensing station is at a candidate site p. The reader is also advised that in the ensuing explanation, we may denote the sensing region of a sensing station at a candidate site p by either vₖ(p) or simply by v(p) with the understanding that for a lot of practical applications involving sensing and sensed stations with a single sensor, k=1, and hence v(p)=vₖ(p).

Note that for clarity in FIG. 4, the reader may observe that we have only illustrated sensing stations with apparently single sensing regions, however the teachings readily apply to sensing stations with multiple sensing regions as will be obvious to skilled artisans. Thus equivalently, sensor 106 in FIG. 4 can be thought of as composed of multiple directional sensors facing in different directions, and thus under this assumption sensor 106 has multiple sensing regions, each depicted by one hatched cone, and its composite sensing region is the one illustrated by the combined/composite omni-directional hatched cones in FIG. 4.

Let us now add a further set of capabilities to the sensing stations, which we will generally call as multi-modal capabilities. As the name suggests, multi-modal sensors or sensing stations have one or more different modes of operation. The mode of a sensing station either entirely governs or at least affects the beam-pattern of the sensing station. In a given mode md, the beam-pattern of a sensing station determines its sensing or visibility region v(p) that we have defined above, specifically denoted by v(p, md) corresponding to mode md in the ensuing explanation. The practical applications of such multi-modal capabilities are numerous. One such set of applications arises as a result of phased-array or switched antennas. Such antennas belong to a general class of antennas called “smart” antennas, and are also sometimes termed as reconfigurable antennas, or adaptive antennas.

Correspondingly, the sensors housing such antennas are oftentimes conveniently called phased-array, switched, reconfigurable, adaptive or smart sensors. It should be noted that a mode encompasses the notion of a logical characteristic, and is thus a ‘logical mode’ of a sensor, rather than a precise physical feature/characteristic, or a physical mode of the sensor, which may be engineered differently for different sensors by different manufacturers. As will be explained below, a mode can be closely associated with the hardware features of the sensor, requiring a set of parameters to define its operation and the eventual production of the radiation/beam/beam-pattern of the sensor, or it can be the eventual radiation/beam/beam-pattern itself, produced as an end result of the internal hardware/firmware mode of the sensor and its associated parameters.

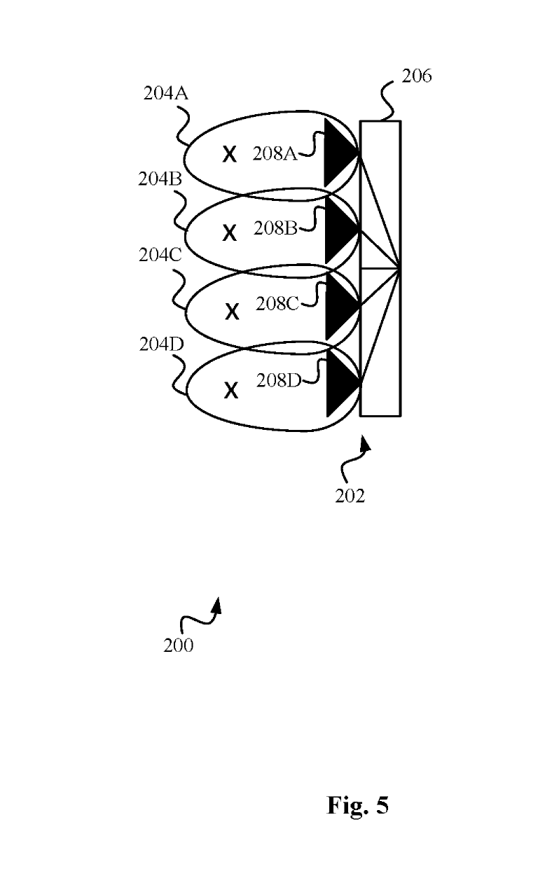

The vital characteristic of such sensors is that they allow electronic reconfiguration of their beam-patterns, and in turn their sensing regions. One such exemplary antenna is illustrated in FIG. 5, containing sensor deployment system 200 of the instant invention. System 200 comprises a phased-array sensing station or sensor 202 that has 4 different beam forming elements 208A-D shown by dark triangles. Phase-array sensor 202 further comprises a beam controller 206 that contains the requisite electronic circuitry to switch activation signals to the 4 different beam forming elements according to the requirements of the application at hand. In a simple version of the sensor deployment system 200 of FIG. 5, each beam forming element 208A, 208B, 208C and 208D, forms its corresponding beam-pattern 204A, 204B, 204C and 204D respectively, corresponding to the 4 modes of its operation 1, 2, 3 and 4 respectively. Each beam-pattern 204A, 204B, 204C, 204D corresponds to a visibility region v(p,1), v(p,2), v(p,3), v(p,4) for the 4 modes of operation 1,2,3,4 respectively of sensor 202. In a more complex variation of the above embodiment, there can be any number of modes of operation of sensor 202 comprising various combination of beam-patterns 204A-D. For example, mode 1 may incorporate beam-patterns 204A, 204B, mode 2: 204B, 204C, mode 3: 204A, 204D, mode 4: 204A, mode 5: 204B, and so on.

Thus the multi-modal sensing stations of the instant invention can incorporate any number of modes with any number of beam-patterns as a result of one or more beam forming elements being activated either singularly or in combination with each other. Furthermore, these modes may be activated/switched in any sequence or order as desired, according to a given switching sequence (further explained below). The switching sequence comprises of time intervals or stages at which this activation or switching of modes occurs. To make things even richer in capabilities, each mode may have an associated set of parameters params(md) governing mode md. In the prior example, the modes of sensing station 202 may have a parameter called field-strength fs that governs how much energy may be radiated by the beam forming element(s) in a given mode. Continuing with the prior example, in mode 1, the field-strength parameter fs will govern the amount of energy radiated by beam forming elements 208A, 208B—this energy in turn then determines how far beam-patterns 204A and 204B will be effective in mode 1. Similarly, the modes of sensing station 202 may have another parameter called heading hg, that governs the angle or direction of the beam-patterns in a given mode. For example, hg=15° in mode 1 may indicate that beam-patterns 204A-B will be tilted by 15° from a chosen axis. Thus, params(1)=(fs,hg)=(5, 15°) where fs=5 indicates the field-strength, and hg=15° indicates the heading.

It will be apparent to one skilled in the art that any number of such combinations of modes and corresponding parameters are possible. Therefore, in the above example, there may be two separate field-strength parameters for mode 1, fs_{A} and fs_{B}, each separately determining the strength of beam-patterns 204A and 204B in mode 1 respectively. Similarly, there may be two separate heading parameters for mode 1, hg_{A} and hg_{B}, each separately determining the heading or direction of beam-patterns 204A and 204B in mode 1 respectively. However, continuing with the prior example, there may only be one field-strength fs and only one heading parameter hg for mode 5, which has only one beam forming element 208B activated during its operation to produce its corresponding beam-pattern 204B. Thus the effective radiation pattern of sensor 202 can be reinforced in desired directions and suppressed in undesired directions. As a result, the sensing region of the sensing station could be one of a plurality of shapes, and the number of possible modes of operation can far exceed the number of beam forming elements (see further below in the discussion of effective-modes).

Recall from earlier teachings that a composite sensing/visibility region v(p), or simply sensing region v(p), of a sensing station is a collection of up to k sensing regions corresponding to various sensors present on the sensing station. So, for a multi-modal sensing station having a total of r modes, there can be r sensing regions v(p,1),v(p,2) . . . v(p,r), each corresponding to a given mode md=1 . . . r of the operation of the sensing station, and each sensing region v(p,1),v(p,2) . . . v(p,r) may itself be a collection or some combination of up to k sensing regions of k sensors present in the multi-modal sensing station.

For a multi-modal sensing station having two modes, sensing region v(p,1) corresponding to its first mode, can be the union of the sensing regions of the 1^{st} and 3^{rd} sensors of the sensing station, while sensing region v(p,2) of its second mode, can be the intersection of the sensing regions of the 2^{nd}, 4^{th} and 5^{th} sensors of the sensing station, while a 6^{th} sensor on the sensing station may not be utilized by either mode and their sensing regions v(p,1) or v(p,2). Then as the above sensing station switches between its two modes, its 1^{st}, 2^{nd}, 3^{rd}, 4^{th} and 5^{th} sensing regions get activated according to the collections defined for composite sensing regions v(p,1) and v(p,2) of its two modes. Furthermore each of the modes 1 and 2 may have their associated parameters params(1) and params(2) to govern their operation as explained above. As an example, params(1) and params(2) may include field-strength fs and heading hg of its beam-patterns, and any other parameters as required by the application at hand to govern the operation of the two modes.

Some examples of such operational parameters of the modes of a sensing station include, but are not limited to, gain (i.e. the gain applied to the signal by the sensor), signal-phase (i.e. the phase or temporal shift applied to the signal), geometry (i.e. the shape and other configuration aspects of the beam), frequency (of the radiated beam), input-power or simply power (drawn at input by the sensor), polarization (of the beam), Time-of-Flight (ToF) imaging, phase-noise and impedance. One skilled in the art of sensors/transducers in a particular field of application will understand the meaning and significance of such parameters and these will not be delved into detail here. At this point, let us also introduce the notion of a composite multi-modal sensing region v^{r}(p) as the collection of r sensing regions v(p,1),v(p,2) . . . v(p,r) corresponding to modes and =1 . . . r of the operation of the multi-modal sensing station, where each of sensing regions v(p,1),v(p,2) . . . v(p,r) may itself be a composite or collection or some combination of up to k sensing regions of k sensors present in the multi-modal sensing station.

Returning to FIG. 5, sensor deployment system 200 further comprises 4 target sites marked by the letter ‘X’ as shown. As stated earlier, in a simple variation of system 200 of FIG. 5, phased-array sensing station 202 of FIG. 5 can be switched such that beam-patterns 204A through 204D are electronically cycled repeatedly in sequence. As mentioned above, this electronic switching is performed by beam controller 206. In other words, in response to phased electronic activation of control signals by beam controller 206, phased-array sensor has r=4 modes corresponding to the activation of its beam-pattern 204A, followed by 204B, then 204C, then 204D and then again beam-pattern 204A and repeating the same cycle. Such electronic activation of beam-patterns of a sensor is also referred to as switching and the activation sequence is also referred to as the ‘switching sequence’. The switching sequence further comprises of stages or intervals of times, at which the beam-patterns are illuminated/activated. Each point of interest ‘X’ is in one of four beam-patterns 204A-D of switching sensor 202 as shown.

As will be apparent from earlier teachings, the switching sequence may be different for other variations of the above embodiment. In those and related variations, the r modes of operation of sensor 202 may comprise activating beam-patterns 204A through 204D in various combinations, while dynamically configuring their field-strengths fs, headings hg according to parameters params(1), params(2) . . . params(r), or simply params={(fs₁, hg₁), (fs₂, hg₂) . . . (fsᵣ, hgᵣ)} corresponding to modes 1 . . . r, or simply r modes. Further, params may comprise additional parameters (beyond field-strength fs and heading hg) as desired to govern the operation of the r modes. Further still, parameters required for the r modes may be different for various modes i.e. mode 1 may require fs and hg, mode 2 may require just hg, while mode 3 may not require any parameter. Note that in the ensuing explanation, we may interchangeably use the term sensing/visibility region of a multi-modal sensing station and the term beam-pattern, knowing that the beam-patterns of the sensing station corresponding to its various modes directly govern its sensing regions v(p,1),v(p,2) . . . v(p,r) correspond to those r modes, and that a beam-pattern may itself be composed of the constituent beam-patterns of various sensors and their beam forming elements on the sensing station, activated according to a given switching sequence.

According to the main aspects of the invention, the placement and switching sequence of switching sensor 202 as determined by the instant invention will guarantee that every target or point of interest ‘X’ will be covered at least a fraction e of time, where e E[1/r̅, 1]. In other words, as switching sensor 202 cycles through its beam-patterns, the placement and the switching order and timing of switching sensor 202 as determined by the present invention guarantees coverage of each point of interest ‘X’ to be a fraction of time that is in the range of 1/r̅ and 1, where r̅ is the number or size of a preselected enumeration/selection of those modes and the associated parameters of sensing stations, over which coverage of points of interest ‘X’ is being sought. Further explained, r̅ represents the number of modes and their associated parameters i.e. (md,params(md))∀md=1, . . . , r̅, from the total number of modes r and their associated parameters i.e. (md,params(md))∀md=1, . . . , r, over which coverage of points of interest ‘X’ is desired.

To elaborate further still, consider an exemplary variation of system 200 shown in FIG. 5 having a total of r=4 modes, each mode corresponding to activating one of four beam-patterns 204A-D as explained earlier, each mode further having a parameter field-strength fs in the range of 1-10 and a parameter heading hg in the range of 0-15°. Then, for a given application, r̅ can be the following subset or enumeration or selection from the entire modes X parameters space: r̅={(1, (2, 0°), (1, (4, 5°)), (1, (6, 10°)), (1, (8, 15°)), (1, (10, 0°)), (3, (2, 3°)), (3, (4, 6°)), (3, (6, 9°)), (3, (8, 12°)), (3, (10, 15°))}, indicating that coverage is desired over mode 1 operating with parameters (fs, hg)=(2, 0°), (4, 5°), (6, 10°), (8, 15°), (10, 0°), and mode 3 operating with parameters (fs, hg)=(2, 3°), (4, 6°), (6, 9°), (8, 12°), (10, 15°). For ease of explanation, sometimes we may refer to each member of set r̅ above as an ‘effective-mode’ comprising a mode along with its implicit parameters. Thus, selection r̅ above has 10 effective-modes over which coverage is desired.

It should be noted that the above exemplary embodiments are explained using single multi-modal sensor environments, however where multiple sensors are present, r̅ is correspondingly expanded to enumerate the additional sensors, their modes and their parameters. Thus, expanding the above example to include two sensors S1 and S2, we can have:

r̅_{S1}={(1, (2, 0°)), (1, (4, 5°)), (1, (6, 10°)), (1, (8, 15°)), (1, (10, 0°)), (3, (2, 3°)), (3, (4, 6°)), (3, (6, 9°)), (3, (8, 12°)), (3, (10, 15°))}, and

r̅_{S2}={(2, (2, 0°)), (2, (4, 5°)), (2, (6, 10°)), (2, (8, 15°)), (2, (10, 0°)), (4, (2, 3°)), (4, (4, 6°)), (4, (6, 9°)), (4, (8, 12°)), (4, (10, 15°))}, with

r̅=r̅_{S1}∪r̅_{S2}, signifying that coverage is desired over the 20 effective-modes contained in r̅ above. This embodiment is an interesting example of a cascade or hierarchy of modes as taught by the invention, that allow the combination of lower level modes of sensors, and their associated parameters, to form higher level or semantically more powerful modes of operation. Thus, taking the example of photoelectric sensors, if a manufacturer provided or internal or hardware/firmware mode is called ‘diffusion’, combined with the appropriate choice of parameters, the semantically higher level modes may be called ‘range=1 ft’, ‘range=5 ft’, and so on.

Let us now study the range of coverage eε[1/r̅, 1] where e is the fraction of time that every point of interest is covered as guaranteed by the instant invention, in more detail. When fraction e=1, that signifies the placement and switching of the sensors or sensing stations is such that each point of interest is covered 100% of the time. For the simple version of the embodiment of FIG. 5 introduced earlier where the four beam-patterns 204A-D are activated, one at a time, cyclically in sequence, that would mean the placement of switching sensor is such that all four targets ‘X’ are under at least one beam-pattern 204A-D, and that all four beam-patterns 204A-D are constantly activated or “lit up”. In other words, each target can be covered by only one beam-pattern, and e=1 signifies the edge case, when there is really no “switching” of beam-patterns, and the switching sensor acts like a conventional sensor, which has the four beam-patterns constantly activated.

Note, for the above example, r=4 modes, and we are choosing r̅=r=4 i.e. we are desiring coverage over all 4 modes and there are no additional parameters params required for the modes. Now let us examine the other edge case, or the extreme of range [1/r̅, 1]. When

$$e = \frac{1}{\overline{r}} ,$$

that signifies the trivial case where the beam-patterns are being switched synchronously with the switching sequence and all activation periods of the beam-patterns equal to each other. For example, referring to FIG. 5, beam-pattern 204A may be on for 4 seconds, then 204B may be on for 4 seconds, then 204C for 4 seconds, then 204D for 4 seconds, and then 204A again for 4 seconds, and so on.

The switching sequence can be thought of as a clock waveform, with a stage/period of 4 seconds for the above example, having switching or transitions between each beam-pattern occurring at the rising edge of the clock waveform. Therefore each point of interest ‘X’ as shown in FIG. 5 will be lit up for

$$\frac{1}{\overline{r}} = \frac{1}{4}$$

of the overall time, which in the above example is 16 seconds or 4 periods of the clock. Therefore, each point of interest ‘X’ will be covered for 16×¼=4 seconds, as pointed out in the initial set up of the example above. Using the above example illustrated in FIG. 5, according to the chief aspects of the present invention, no matter what the value of the uniform rate/speed of the switching sequence, each point of interest ‘X’ will be covered at least a fraction e of the time where e is in the range

$$[ \frac{1}{\overline{r}} - 1 ] .$$

The present invention accomplishes this coverage by using the below presented Modified Greedy Algorithm 1—a modified version of the well-known Greedy algorithm. Note that in the algorithms described below, and ensuing explanation, a candidate site p includes the location and configuration of sensing station as taught above. The configuration can include orientation of the sensing station ((x,y,θ) in two dimensions, or (x, y, z) and Euler angles in three dimensions, or another suitable representation in n-dimensions as taught above, where n is a whole number greater than 1). In addition, candidate site p also includes the mode of operation of the sensing station along with the parameters required for the operation of that mode. Thus, drawing from above definition of an effective-mode, a candidate site p includes the location, configuration and the effective-mode of sensing station. Note, for clarity in the ensuing explanation, we will refer to an effective-mode md, without explicitly mentioning the parameters params (taught above) required for its operation, with the knowledge of the implicit presence of the supporting parameters params required for the operation of the mode.

The set of candidate sites P={p₁, p₂, . . . , pₘ} is created such that each candidate location/configuration of the sensing stations, along with their effective-modes as contained in set r̅ (i.e. their modes along with their associated parameters params as taught above), are represented in set P. As an example, if a system has a multi-modal station having 2 effective-modes, A and B, and there are 2 possible candidate site locations (x₁,y₁) and (x₂,y₂) and 2 possible orientations θ₁ and θ₂ at those candidates sites for the sensing station, then set P can be initialized as follows: P={(x₁, y₁, θ₁)_{A}, (x₁, y₁, θ₁)_{B}, (x₁, y₁, θ₂)_{A}, (x₁, y₁, θ₁)_{B}, (x₂, y₂, θ₁)_{A}, (x₂, y₂, θ₁)_{B}, (x₂, y₂, θ₂)_{A}, (x₂, y₂, θ₂)_{B}}. Since the below presented algorithms choose the placement sites from the candidate sites, it follows directly that the placement sites as determined by the algorithms, will also include the placement location and configuration of the sensing station, as well as the effective-modes that the sensing station should be in during the chosen time period(s) or stage(s) of the switching sequence of the modes.

One use-case of the following Modified Greedy Algorithm 1 assumes that each sensing station is driven by the same clock, and thus follows the same switching sequence. However, each sensing station can commence the sequence differently. In other words, given a periodic effective-mode switching sequence {md₁, md₂, . . . , md_{r̅}}, a candidate site s₁=(x₁, y₁, θ₁; 1) would signify the periodic switching sequence {md₁, md₂, . . . , md_{r̅}}, whereas candidate site s₂=(x₂, y₂, θ₂; 3) would signify the periodic switching sequence {md₃, md₄, . . . , md_{r̅}, . . . , md₁, md₂}. Therefore, selecting candidate site s₁ implies the selection of r̅ visibility regions vₜ(s₁) for each time/stage of the switching sequence t=1, 2, . . . , r̅, and selecting candidate site s₂ similarly implies the selection of r̅ visibility regions vₜ(s₂) for each time/stage of the switching sequence t=1, 2, . . . , r̅.

Another use-case covered by the following algorithm assumes that the sensing stations share the same clock but are free to select any effective-mode at time/stage t of the switching sequence, independently of the effective-mode selected at time/stage t−1 of the switching sequence, or the modes that the other sensing stations are in. Assuming a period of interest of 5 clock cycles, a candidate site s₁ can thus be (x₁, y₁, θ₁; md₁, md₃, md₅, md₇, md₉), while candidate s₂=(x₂, y₂, θ₂; md₄, md₈, md₃, md₂, md₆). Therefore, selecting candidate site s₁ implies the selection of 5 visibility regions v(s₁)=v_{md1}(x₁, y₁, θ₁), v_{md3}(x₁, y₁, θ₁), v_{md5}(x₁, y₁, θ₁), v_{md7}(x₁, y₁, θ₁), v_{md9}(x₁, y₁, θ₁) at time/stage t=1, 2, 3, 4, 5 respectively of the switching sequence, and selecting candidate site s₂ similarly implies the selection of 5 visibility regions v(s₂)=v_{md4}(x₂, y₂, θ₂), v_{md8}(x₂, y₂, θ₂), v_{md3}(x₂, y₂, θ₂), v_{md2}(x₂, y₂, θ₂), v_{md6}(x₂, y₂, θ₂), at time/stage t=1, 2, 3, 4, 5 respectively of the switching sequence. Note as mentioned earlier, in the above example, we have omitted the explicit mention of the associated operational parameters params of r̅ effective-modes of the sensing stations.

It should be noted that the below algorithm covers other related use-cases and embodiments not explicitly explained in this detailed explanation, but supported by the principles and teachings of the instant invention. Other use-cases with differing sets of candidate sites P and resulting computational complexity are solvable by the following modified version of the popular Greedy algorithm.

Modified Greedy Algorithm 1:
10. Start with the set of all target sites or points of interest, Xᵢₙᵢₜ={q₁, q₂, . . . , qₙ}; the set of candidate sites, P={p₁, p₂, . . . , qₘ} as per above explanation; and set eε[1/r̅, 1] to the desired value of coverage.
20. Initialize ground/target sets corresponding to each stage of the switching sequence/cycle, X₁=X₂= . . . =X_{r̅}=Xᵢₙᵢₜ; an n-vector x̅=[1, 1, . . . , 1] corresponding to |Xᵢₙᵢₜ|; and the set of placement sites to be determined S=Ø (empty set).
30. Select candidate site sεP that maximizes Σⱼ₌₀^{r̅}|vⱼ(s)∩Xⱼ|. //* Choose the placement site for which the location/placement and switching sequence yields a coverage that is the largest amongst the remaining ground/target sets *//
40. Set

$${x}_{i} ← max ( 0 , {x}_{i} - \frac{d}{e \overline{r}} )$$

with d=Σⱼ₌₀^{r̅}|vⱼ(s)∩Xⱼ| for ∀i=1, . . . , n; set Xᵢ←Xᵢ\vⱼ(s) for ∀i=1, . . . , r̅; set P←P\s; and set S←S∪s //* Update each entry of n-vector x̅ to the fraction of time the corresponding target site is uncovered, given e. If that entry ≦0, then that means the desired coverage of that target site has been accomplished. Remove the covered target sites from each target set. Remove the candidate sites thus processed from P and add them to S. *//
50. If x̅.x̅>0, then go to step 30, else exit. //* Continue as long as there are any remaining target sites whose desired coverage according to e has not yet be achieved. *//

The above algorithm of the instant invention guarantees that for the placement sites of switching sensors represented by set S, all points of interest or targets will be covered at least a fraction e of the time. Target sets represent the set of points/locations/targets of interest that are desired to be covered at each stage of the switching sequence. Note that all target sets X₁ . . . X_{r̅} in the above algorithm are the same i.e. they are equal to the set Xᵢₙᵢₜ comprising all targets sites or points of interest. In other words, in the above embodiment, even though we have various target sets corresponding to the various modes of the sensors, the algorithm operates on target sets X₁ . . . X_{r̅} and the ground set Xᵢₙᵢₜ, that consist of all target sites of the problem at hand.

Before moving on from the embodiments illustrated by FIG. 5, let us consider one more embodiment of a phased-array sensor aptly depicted by FIG. 5. In this embodiment, beam forming elements 208A-D are internally parameterized, typically at the firmware level, to accept parameters including field-strength fs, signal-phase sp, and heading hg. Based on the internal configuration or commands programmed in sensor 202, beam forming elements 208A-D are activated individually, simultaneously or in various combinations, along with their parameters including fs, sp and hg as explained above, to enhance their beams in certain ways and to suppress their beams in other ways, and thus forming a resultant beam-pattern or simply, beam, of sensor 202. As a result, this resultant beam/beam-pattern of sensor 202 can be carefully programmed/structured/configured to have a specific shape, geometry and direction.

Furthermore, beam forming elements 208A-D can be switched at various time instants/stages of a switching sequence to produce a potentially very large number of pre-programmed beam-patterns of sensor 202 corresponding to those instants/stages of the switching sequence. Each such resultant beam-pattern produced by sensor 202 in turn comprises some combination of one or more of its constituent beam-patterns from beam forming elements 208A, 208B, 208C, 208D that have been ‘mixed and matched’ in appropriate manner to form a specific resultant beam-pattern from sensor 202 at a given stage of the switching sequence.

Recall from earlier teachings, that a mode in this disclosure encompasses the notion of a logical characteristic of a sensor rather than a precise physical feature/characteristic, which may be engineered differently for different sensors and by different manufacturers. Therefore in the above example, the mode can be construed as an internal mode of sensor 202 that is appropriately parameterized to provide the above functionality. In other words, mode md=1, 2, 3, 4 can signify switching on beam forming elements 208A, 208B, 208C, 208D respectively, such that more than one of modes md=1, 2, 3, 4 can be activated at a given time, and each of modes md=1, 2, 3, 4 can accept its appropriate operational parameters, including fs, hg and sp i.e. params={(fs₁, hg₁, sp₁), (fs₂, hg₂, sp₂), (fs₃, hg₃, sp₃), (fs₄, hg₄, sp₄)}, and the resultant beam-pattern characterized by a composite visibility region v(p) is formed as a result of a set or a non-set or some mathematical operation on the constituent beam-patterns or visibility regions v(p,1),v(p,2),v(p,3), v(p,4) corresponding to the 4 internal modes md=1, 2, 3, 4.

Thus, if each of modes md=1, 2, 3, 4 requires the 3 parameters fs, hg and sp, or differently said, if sensor 202 has 4 effective-modes with 3 associated parameters each, and if each of these 3 parameters can have 2 different values, then the reader is invited to verify that potential number of resultant beam-patterns of sensor 202 can be 6560, and these 6560 distinct beam-patterns can be activated according to a switching sequence. In practice however, it may turn out that because of various reasons including convenience, similarity between the beam-patterns, reliability testing performed on the beam-patterns, that one may choose a much smaller subset of the 6560 beam-patterns for coverage, for example, 24 beam-patterns. In such a scenario, r̅=24 for determining coverage using the above teachings and algorithm.

Alternatively, however, the mode of sensor 202 in the above embodiment can be logically chosen to be the resultant beam-pattern itself, having 6560 distinct values. In such a scenario, we are not concerned with the parameters associated with the mode, because they are internally provided to the sensor, and we are only concerned about the extrinsic behavior/properties of sensor 202 as a result of its internal configuration/parameterization. Thus, mode md is conveniently characterized by a resultant beam-pattern produced by sensor 202, with the tacit inclusion of any internal or implicit parameters responsible for creating the mode. Recall that this matches with our notion of the effective-mode as taught earlier. Effective-modes/modes can then be switched on and off according to a switching sequence as explained in reference to other embodiments. Once again, for practical purposes a much smaller number than 6560 modes may be chosen for coverage, for example, r̅=24 for the choice of mode md. To summarize, with any appropriate choice of logical mode md of the sensing stations in the various embodiments of the instant invention, with the appropriate formation of set P of candidate sites and set r̅ as taught above, the algorithms and teachings taught to arrive at the respective solutions hold.

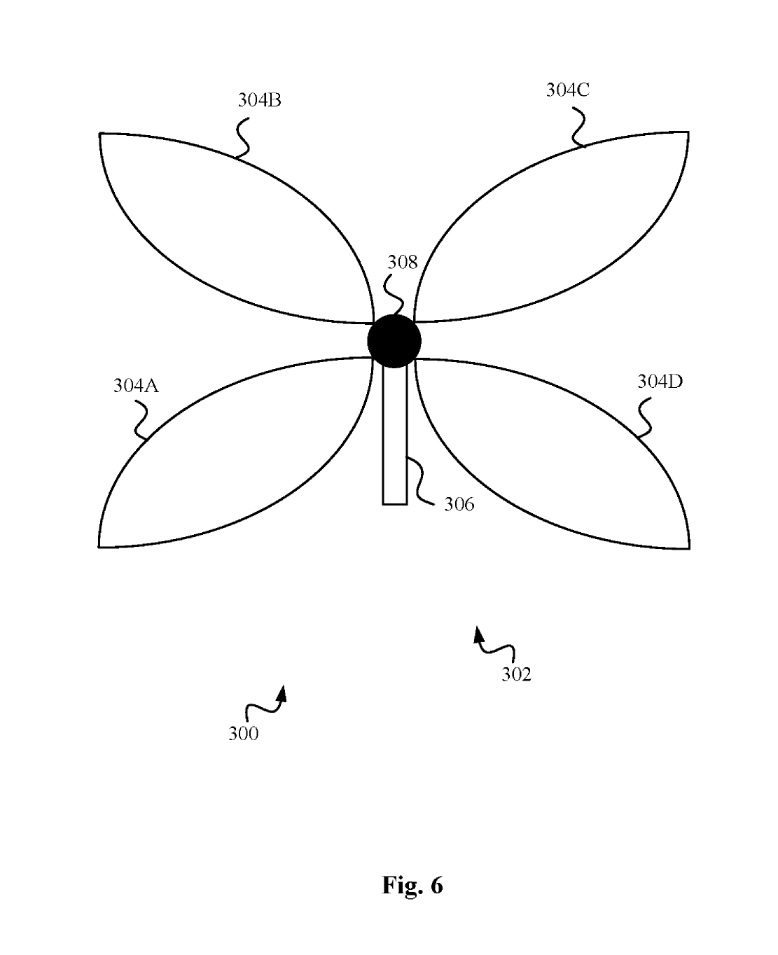

Now let us look at another embodiment, as illustrated in FIG. 6, of multi-modal sensor deployment system 300 and its methods according to the present invention. FIG. 6 shows a multi-modal sensing station 302 having a beam controller 306 and a beam forming device 308, which can be composed of a plurality of beam forming elements. For explanatory purposes we assume that such a beam forming device 308 can switch/activate one of four beam-patterns. Thus, sensing station 302 can select one among four modes corresponding to sensing regions 304A, 304B, 304C and 304D, as shown. One possible operation of the exemplary embodiment of FIG. 6 could be that each beam-pattern 304A-D is switched in sequence for equal activation times. Another possible operation could be that North-East (N-E) and South-West (S-W) beam-patterns 304C and 304A respectively are activated together, followed by North-West (N-W) and South-East (S-E) beam-patterns 304B and 304D respectively, then N-E and S-W again, followed by N-W and S-E again, and so on. Time periods for which these pairs of beam-patterns are activated can be uniform or varying. Similarly other activation sequences are possible as will be obvious to the reader of average skill.

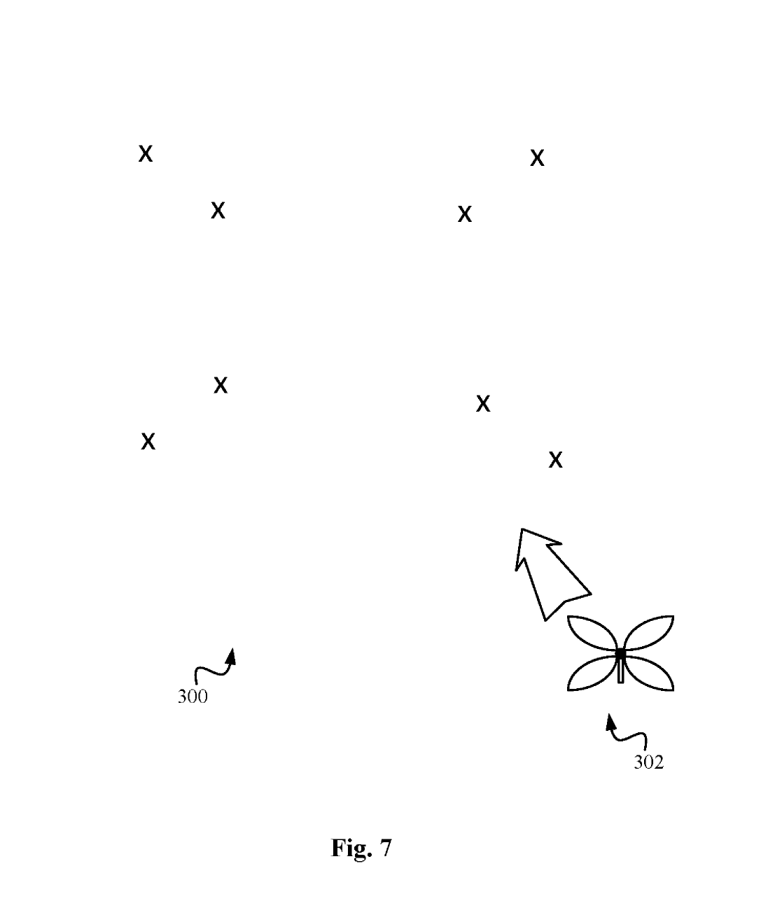

Now let us introduce some targets whose coverage is desired. A set of such exemplary targets are illustrated by ‘X’ in multi-modal sensor deployment system 300 shown in FIG. 7. The system and methods of the present invention will determine a placement site, including a location and orientation, as well as a switching sequence of multi-modal sensor 302 such that each target ‘X’ is covered at least a fraction e of the time. Note that because of the symmetrical nature of this problem, the number of targets that are required to be covered under each beam-pattern or mode of this sensor are the same i.e. 2 if each mode activates one beam-pattern, or 4 if each mode activates two beam-patterns.

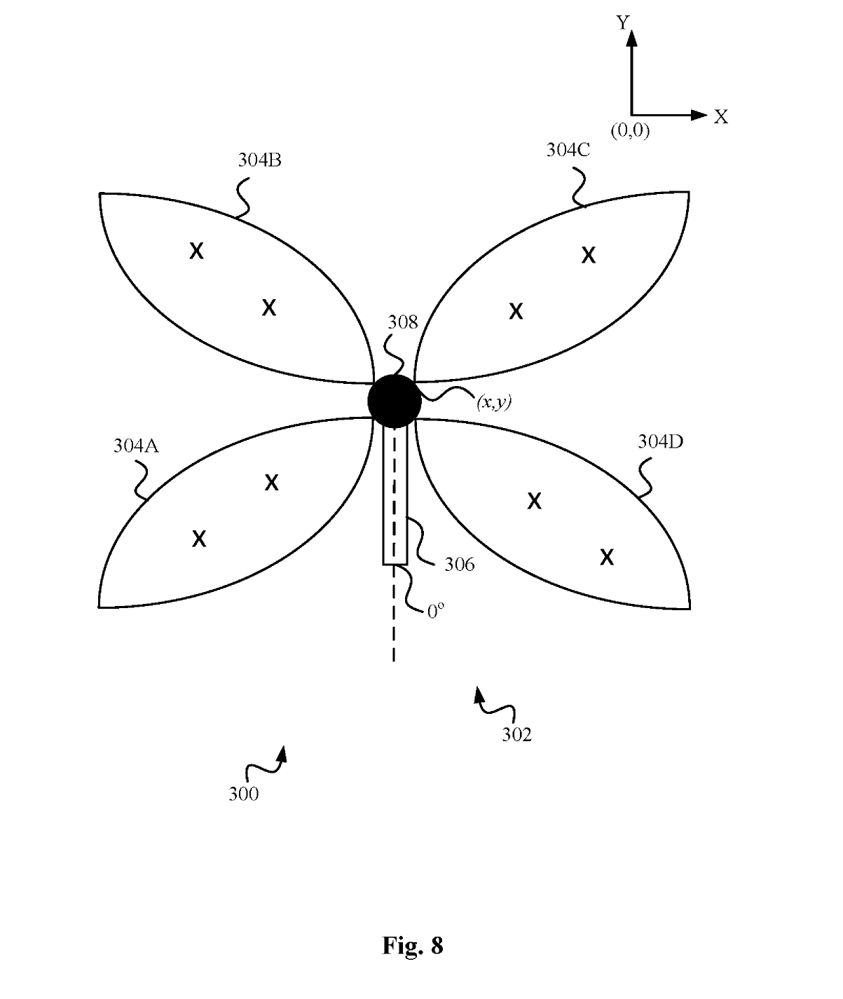

We refer to the targets corresponding to a beam-pattern or mode at a given stage of the switching sequence, as target set. Whether the target sets in FIG. 7 has 2 or 4 targets, using Modified Greedy Algorithm 1 above of the instant invention, a solution is illustrated in FIG. 8. The solution consists of the placement or location of sensor 302 at position (x,y) with respect to the two-dimensional Cartesian coordinate system represented by X-axis and Y-axis as shown, and an orientation of 0° with respect to the Y-axis as shown by the dashed line, such that each target ‘X’ is covered at least a fraction of time e. It is understood that although the exemplary illustration in FIG. 7-8 is shown in two-dimensions for convenience only, but the teachings of this disclosure apply directly to three or higher dimensions. Therefore, in a 3-D environment, the solution derived using the instant invention could have been represented by (x, y, z) coordinates in a three-dimensional coordinate system along with the three Euler angles (φ, θ, ψ) or some alternate three-dimensional representation.

In the embodiment represented in FIG. 7-8, if each mode of sensor 302 activates one beam-pattern, then the solution computed by Modified Greedy Algorithm 1 as shown in FIG. 8 would comprise location and orientation (x,y,0°) and a possible switching sequence of 304A, 304B, 304C, 304D, 304A . . . . Conversely if each mode of sensor 302 activates two beam-patterns as explained earlier, then the solution computed by Modified Greedy Algorithm 1 as shown in FIG. 8 would comprise location and orientation (x,y,0°) and a possible switching sequence of (304A, 304C) followed by (304B, 304D), then (304A, 304C) and so on.

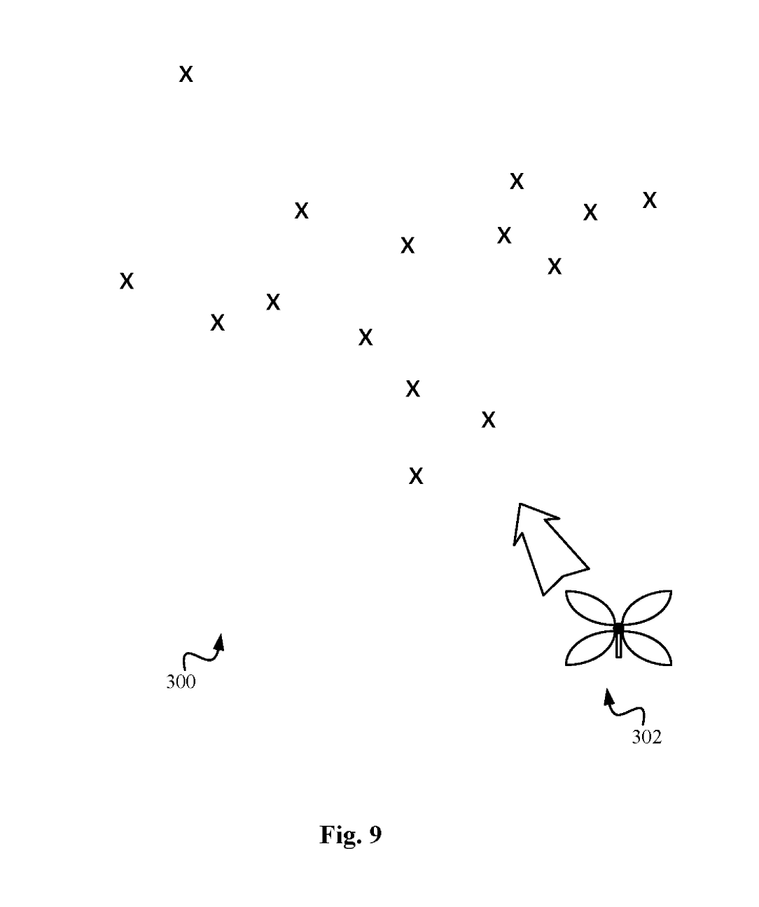

Let us now generalize our algorithm to include target sets that can differ from each other at various points in time or stages in the switching sequence. This is also referred to as temporal “unfolding” of the targets. From a practical standpoint, such a scenario is quite likely as the targets that are desired to be covered for various modes or stages of the switching sequence could be different. One such uneven distribution of targets is shown in FIG. 9. According to the invention, the below algorithm is the generalized version of a modified Greedy algorithm that can compute the solution to differing target sets that may or may not have the same target sites. That is, the sets X₁, X₂, . . . , X_{r̅} may differ, and in general Xₜ denotes the targets of interest at time t. The below algorithm guarantees coverage according to a generalized performance measure ε. Performance measure ε can be a measure of time i.e. minimum time for which the algorithm provides coverage for each target, or as presented below, it could be a 1 or 0 (or yes/no) measure that ensures that each target is covered during at least one stage of the switching sequence. Alternatively it could be any other performance measure according to the application at hand as will be understood by person of average skill in the art. For example, it could also be a fraction of time as in the algorithm presented earlier that ensures that each target is covered at least a fraction of time in the range

$$[ \frac{1}{\overline{r}} - 1 ] .$$

Let us use a set of binary functions c(t)ε{0,1}ⁿ to track targets of interest that remain uncovered at time t, where n represents the total number of targets/points of interest {q₁, q₂, . . . , qₙ} That is, cᵢ(t)=1 if target qᵢεXₜ and 0 otherwise. Therefore, the non-zero values of c(t) correspond to the targets of interests that remain uncovered at time t. As in the case of Modified Greedy Algorithm 1 above, one use-case/embodiment of the below algorithm makes the assumption that each sensing station is driven by the same clock waveform and follows the same switching sequence, but can commence the sequence differently. Also, as in the case of Modified Greedy Algorithm 1 above, in an alternative use-case, the sensing stations share the same clock but are free to select any mode at time t, independently of the mode selected at time t−1 or the operation of other sensing stations. The below Modified Greedy Algorithm 2 applies to the above use-cases.

It should be noted that the below Modified Greedy Algorithm 2 covers other related use-cases and embodiments not explicitly explained in this detailed explanation, but supported by the principles and teachings of the instant invention. Other use-cases with differing sets of candidate sites P and resulting computational complexity are solvable by the following modified version of the popular Greedy algorithm.

Modified Greedy Algorithm 2:
10. Start with target sets {X₁, X₂, . . . , X_{T}} at time t=1, 2, . . . , T, representing the target sites or points of interest from {q₁, q₂, . . . , qₙ}; set of candidate sites P={p₁, p₂, . . . , pₘ} according to previous explanation; and a performance measure ε=f(c(0), c(1), . . . , c(t))—see section below titled Examples of Performance Measure E for choices of f.
20. Initialize c(t) for ∀t such that cᵢ(t)=1 if qᵢεXₜ and 0 otherwise; and the set of placement sites to be determined S=Ø (empty set). //* Initialize each component of performance measure E to track those sites that have not yet been covered, per above teachings. Also initialize set S of placement sites to be determined to an empty set. *//
30. Select candidate site sεP that maximizes Σₜ₌₀^{T}|vₜ(s)∩Xⱼ|.//* Choose the placement site for which the location/placement and switching sequence yields a coverage that is the largest in all instants/stages of time t=1, 2, . . . , T combined/altogether, amongst the remaining target/ground sets *//
40. Set cᵢ(t)←0 if qᵢεvₜ(s) for ∀i=1, . . . , T; set Xₜ←Xₜ \vₜ(s) for ∀i=1, . . . , T; set P←P\s; and set S←S∪s //* Update each component of performance measure ε at stage t of the switching sequence such that for each target site visible in vₜ(s), set corresponding component to 0. Remove the covered target sites from each target set at each time instant/stage. Remove the candidate sites thus processed from P and add them to S. *//
50. If performance measure ε>0, then go to step 30, else exit. //* Continue as long as there are any remaining target sites whose coverage has not yet be achieved. *//

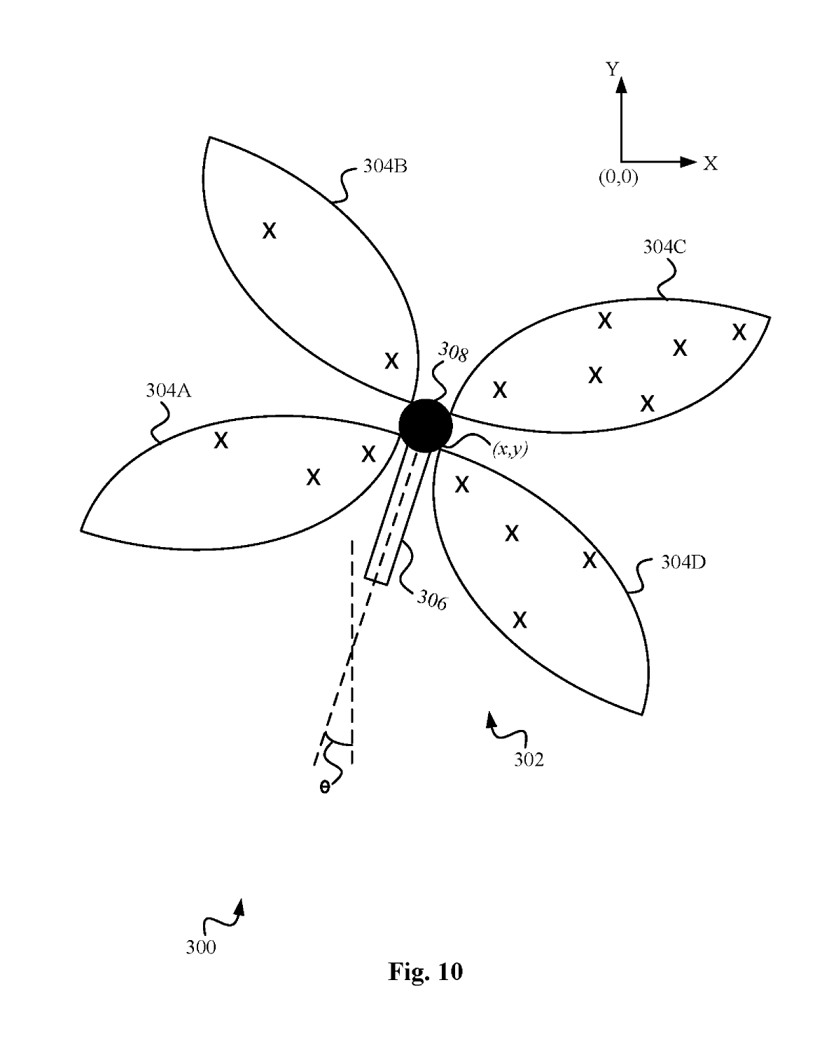

Using the Modified Greedy Algorithm 2 above, a solution to the coverage problem illustrated in FIG. 9, is presented in FIG. 10. The solution consists of the placement or location of sensor 302 at position (x,y) with respect to the two-dimensional Cartesian coordinate system represented by X-axis and Y-axis as shown, and an orientation θ with respect to the Y-axis as shown, such that each target ‘X’ is covered according to performance measure ε i.e. is covered during at least one mode of the switching sequence for a period of time >0. As shown, the target sets corresponding to each stage of the switching sequence are different from one another. The solution also provides the switching sequence of beam-patterns 304A-D. If sensor 302 activates one beam-pattern at a time, then the switching sequence would be 304C, 304D, 304A, 304B. If sensor 302 activates two beam-patterns at a time as explained earlier, then the computed switching sequence would be (304A, 304C), then (304B, 304D).

Once the placement and switching sequence of sensor 302 have been computed as above, the switching sequence can repeat or cycle in the computed order according to the needs of the application. It should be noted that each mode can have associated parameters params that together with the mode, constitute the effective-mode of the operation of sensor 402 as per prior teachings. Therefore, the references to a mode in these teachings should be understood to include the notion of the parameters governing each mode, and the consequent expanded notion of an effective-mode per above explanation.

One will observe, that the above Greedy algorithm ensures that beam-patterns or modes or sensing regions having the largest coverage of targets are selected first during the iterations of the modified Greedy algorithm, and hence the above choice of the order/switching sequence of beam-patterns 304A-D. It is once again understood that the exemplary illustration in FIG. 9-10 is shown in two-dimensions for convenience only, and that the teachings of this disclosure apply directly to three or higher dimensions. Therefore, in a 3-D environment, the solution derived using the instant invention could have been represented by (x, y, z) coordinates in a three-dimensional coordinate system along with the three Euler angles (φ, θ, ψ) or some alternate three-dimensional representation. Furthermore, target sets {X₁, X₂, . . . , X_{T}} above can differ not only in their locations as in the embodiment illustrated in FIG. 9, but also in other coverage criteria. For example, some points ‘X’ in FIG. 9 may need to be covered every clock cycle, while others, only every other clock cycle. Other such varying characteristics of target sites/points are possible within the spirit of the invention, and supported by the above algorithm, as will be observed by the skilled reader.

As explained earlier, performance measure E can be any suitable measure according to the application of the invention. Referring to the algorithm above, here are some practical choices of performance measure E, however other choices are entirely conceivable according to the principles of the invention.

Examples of Performance Measure E:
1. With ε=b.b, where b is a t-vector, and if we let its i-th component bᵢ=Σ_{∀t}cᵢ(t), that represents the edge case that all targets need to be covered/guarded all the time.
2. With ε=b.b, where b is a t-vector, and if we let its i-th component bᵢ=min_{tε{1, . . . , T}}cᵢ(t), that guarantees that each target is covered/guarded at least one time.
3. With ε=b.b, with a parameter

$$e = [ \frac{1}{T} , 1 ] ,$$

where b is a t-vector, and if we let its i-th component bᵢ=max(0,Σ_{∀t}cᵢ(t)−(1−e)T), that guarantees that each target is covered/guarded at least a fraction of time e, and this case is analogous to the Modified Greedy Algorithm 1 present earlier.
4. A variation of example 1, 2 or 3 above but setting ε=(b.b/n²)−ρ², would guarantee that at most a fraction ρ of the targets remain uncovered according to the respective interpretation of coverage in the examples 1, 2 or 3 above.

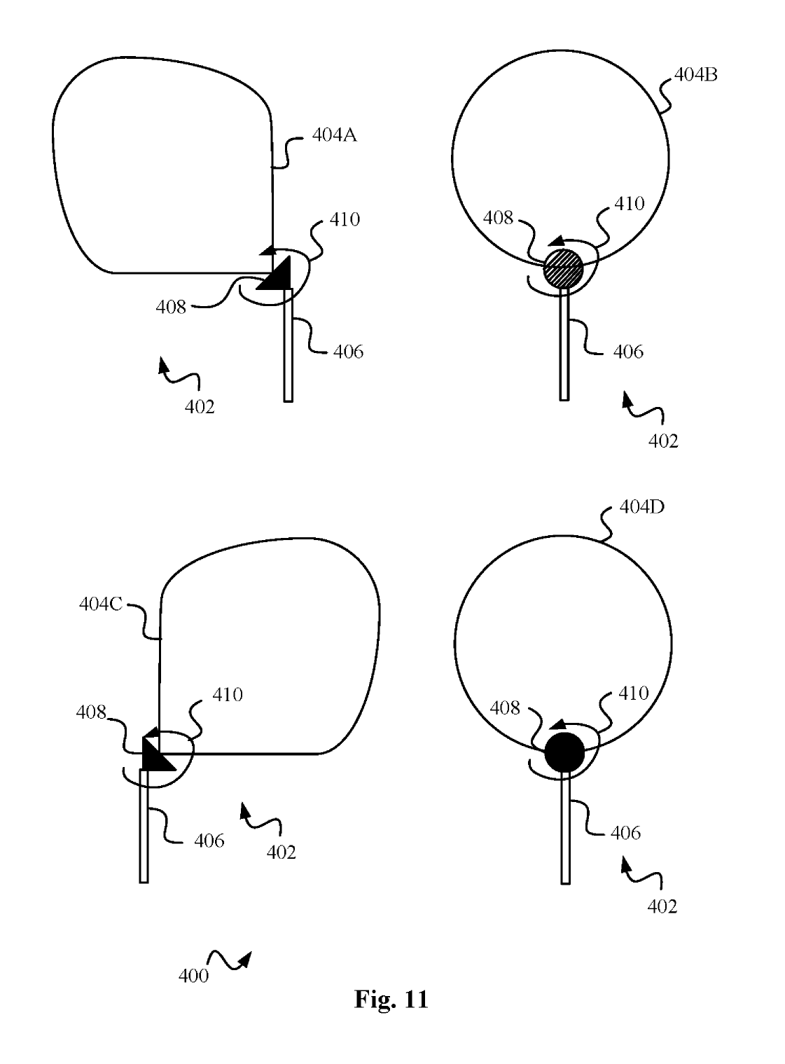

Notice that by their very nature, the Greedy algorithms presented above, in each iteration, will favor the most far-reaching or encompassing sensors and modes. Now let us look at another variation of multi-modal sensors according to the present invention as illustrated in FIG. 11. Unlike the sensors of previous examples, multi-modal sensor deployment system 400 shown in FIG. 11 comprises a rotating sensing station 402. Sensing station 402 has a beam element 408 and a beam controller 406. The sensing region created by beam element 410 is approximately conical in shape as shown and has a limited range. As beam element rotates in counter-clockwise direction 410, its sensing region rotates from its position 404A to 404B, then to 404C and 404D, and once again 404A, and so on. It should be noted that in the two-dimensional drawing of a three-dimensional system as shown in FIG. 11, position 404B of the sensing region corresponds to its beam-pattern facing out of the page of the drawing and towards the reader, and position 404D of the sensing region corresponds to its beam-pattern facing inwards into the page and away from the reader.

It is possible that beam controller 406 rotates with beam element 408 or it may also be stationary while just beam element 408 rotates. Note that it is entirely possible that beam element 408 and beam controller 406 may be combined into a single component and housing. Similarly, one skilled in the art will have several ways to structure and design such a sensing station, and the specific design and embodiments shown in this disclosure are by way of examples only, while the principles of the invention apply to other conceivable designs not specifically shown. Further, as directional sensing station 402 shown in FIG. 11 rotates, there will be other intermediate positions between 404A-D possible, which are not specifically shown. In the embodiment shown in FIG. 11, each position of the sensor corresponds to a mode as taught earlier. Therefore, it can be concluded that the example sensor 402 of FIG. 11 has four modes 404A-D, while one skilled in the art will understand that there can be additional modes corresponding to the various possible positions of sensor 402 during its rotation, that are not specifically shown in FIG. 11. Furthermore, each mode can have associated parameters params that together with the mode, constitute the effective-mode of the operation of sensor 402 as per prior teachings.

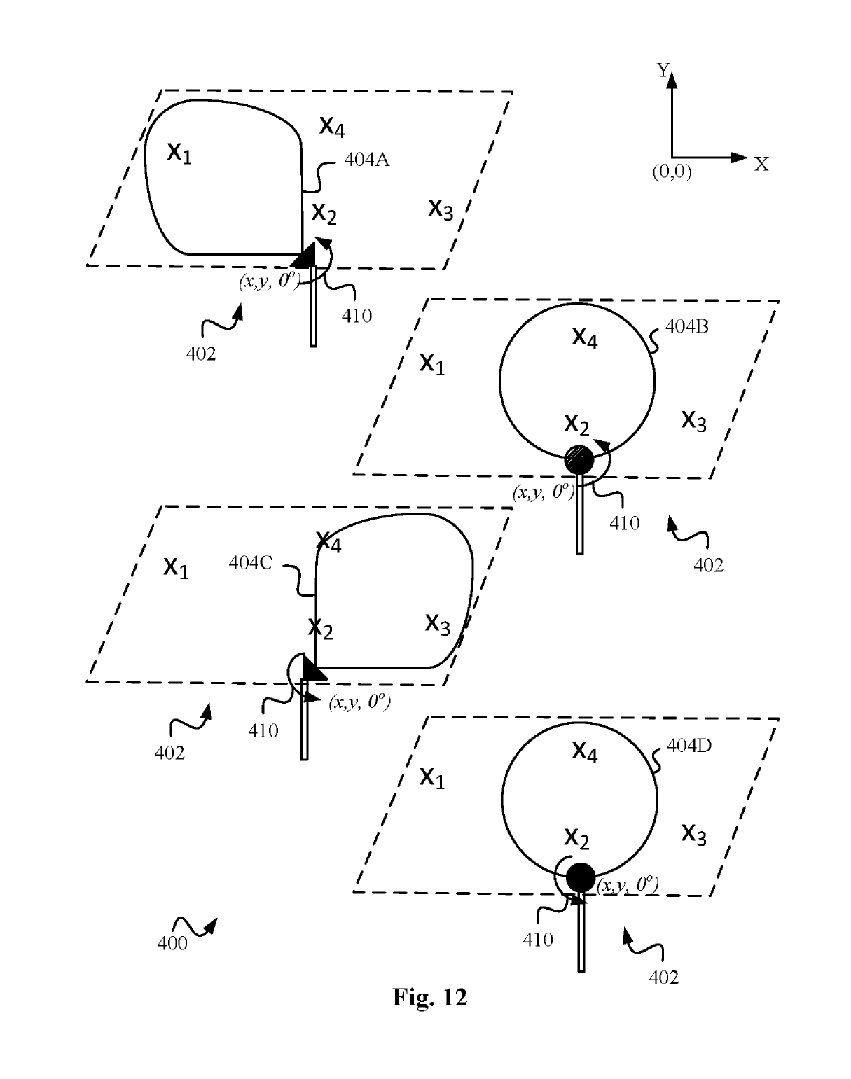

Now let us introduce some target sites or points that are required to be covered by sensor 402. These target points are shown in FIG. 12 and are marked by as X₁, X₂, X₃ and X₄. In FIG. 12, several reference numerals from FIG. 11 have been omitted for clarity. In the example shown in FIG. 12, the targets are presumed to be on the ceiling of the room, in which sensor 402 needs to be placed. The room ceiling is depicted by the dashed line and the four targets to be covered are depicted as X₁, X₂, X₃, X₄. From FIG. 11 we know that as sensor 402 rotates in counter-clockwise direction 410, it switches through four modes, each corresponding to a position of its beam-pattern or sensing region 404A-D. Then according to the instant invention and the Modified Greedy Algorithm 2 presented above, the location of sensor 402 as determined by the algorithm is represented by (x,y) coordinates in the two-dimensional X,Y coordinate system shown, along with the orientation of 0° of the sensor with respect to the Y-axis, as well as a switching sequence of sensor 402 that would satisfy the chosen performance measure E.

Explained further, if performance measure E is chosen per example (1) of ‘Examples of Performance Measure E’ section above, then the switching sequence will keep all sensing regions 404A-D or modes on all the time, because each target X₁ . . . X₄ can be covered by only one of four beam-patterns 404A-D. If performance measure E is chosen as per example (2) above, then a number of solutions are possible for the switching sequence that will ensure coverage of each target at least one time, including the sequence 404A, 404C, 404B, 404D. If performance measure ε is chosen as per example (3) above, then again a number of switching sequences are possible that will guarantee coverage for a fraction of time in the range

$$[ \frac{1}{T} , 1 ]$$

—depending on the chosen value of the fractional coverage as explained in reference to Modified Greedy Algorithm 1 above. If performance measure ε is chosen as per example (4) above with ρ=0.25, that would imply that at most ¼^{th} of the total number of target sites i.e. (¼)×4=1 of the target sites will remain uncovered, and a possible switching sequence could be 404A, 404B, 404D (with 404C being omitted).

As illustrated in FIG. 11, the four modes of sensor 402 depict coverage of target X₁ on the ceiling when sensor 402 has its sensing region in position 404A, coverage of target X₂ on the ceiling, when sensor 402 has its sensing region in position 404B, coverage of target X₃ on the ceiling at position 404C and coverage of target X₄ on the ceiling at position 404D. Because of the two dimensional nature of the drawing of FIG. 12, it may appear that both targets X₂ and X₄ are covered at position 404B, however it should be understood that the position of sensing region 404B is facing outwards towards the reader, and hence the only target covered at position 404B is X₂ only (and not X₄). Similarly at position 404D, sensing region is looking into the page of the drawing and away from the reader, and hence the covered target is X₄ only (and not X₂).

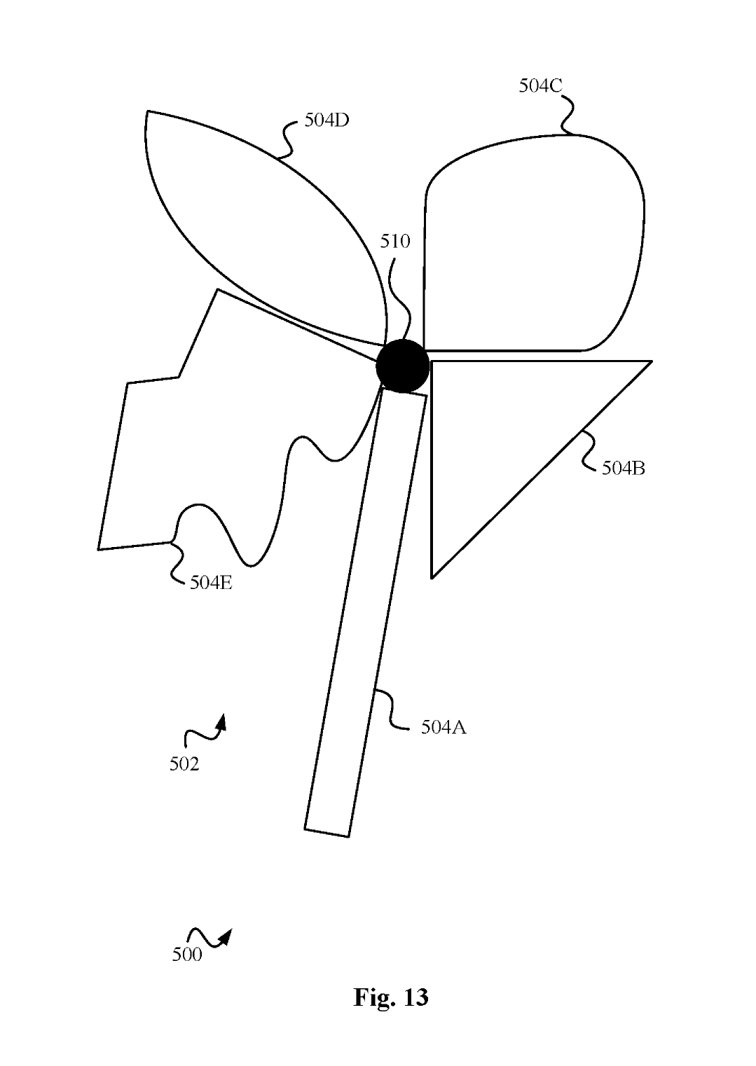

It should also be understood that it is entirely possible under the teachings of the present invention to have sensing regions and modes of a sensing station that are irregular and asymmetrical in shapes and sizes. Such a sensor 502 is shown in the sensor deployment system 500 of FIG. 13. Note that sensing station 502 has a single element 510 that is responsible for controlling and creating the beam-patterns and includes any other related electronics or other types of components. Corresponding to the various modes of operation of sensor 502 it creates several different types and shapes of beam-patterns 504A-E as shown.

In a further variation of the above embodiments, the switching sequence of the sensing stations is predetermined. In other words, the solution computed by the invention determines the placement and orientation of the sensing stations only, while the switching order or sequence of the sensing stations stays fixed. Such is the case in practical applications where the sensing stations have a fixed order of modes and they simply switch between those modes according to a factory configured or manufactured order that cannot be reconfigured. In a similar embodiment, at each given stage or time period of the switching sequence, each sensing station is in the same mode of operation. This is also easily conceivable if there is a set of identical sensing stations in synchronous operation, which are activated into the same mode of operation in unison. In related embodiments, while the sensing stations may be in the same mode, their operating parameters params may be allowed to differ from each other. In other words, their effective-modes may be different from one another. However, their effective-modes may also be identical for some subset or all of the sensing stations in such and related embodiments.

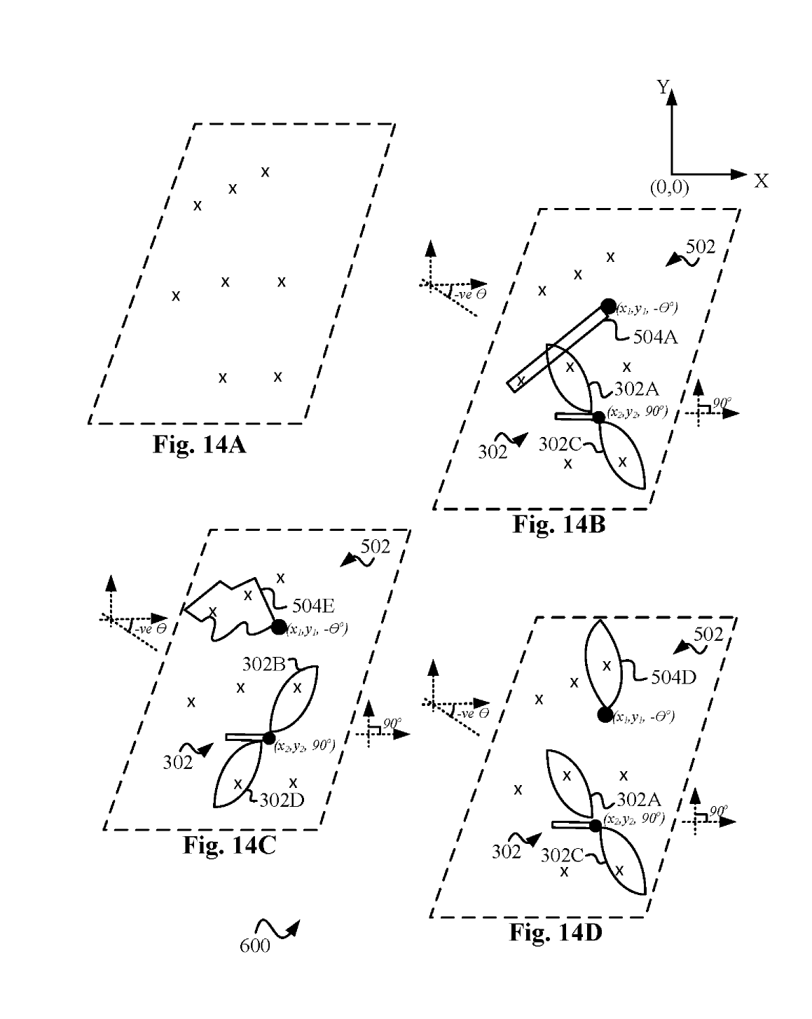

In another example of the multi-modal sensor deployment system according to the present invention, FIG. 14A-D depict a system 600 with a workspace identified by the dashed line having targets identified by ‘X’ that need to be covered by the sensors 302 and 502 of FIG. 6 and FIG. 13 respectively. FIG. 14B-D depict a solution as computed by the instant invention. Specifically, FIG. 14B-D illustrate the placement of (x₁,y₁) of sensor of FIG. 13 and placement (x₂,y₂) of the sensor of FIG. 6, along with their respective orientation with respect to the Y-axis of the coordinate system shown i.e. an orientation of −θ for sensor 502 from its orientation shown in FIG. 13 and a right-angled orientation of 90° for the sensor 302 from its orientation shown in FIG. 6.

As sensors 302 and 502 change modes, their sensing regions corresponding to various modes cover all the targets at various stages in the switching cycle. It is important to note that since all targets are covered by the modes illustrated in FIG. 14B-D, depending on the chosen performance measure E, the computed solution of the instant invention may not pick modes depicted with sensing regions 504B and 504C of sensor 502 in FIG. 13, but rather only choose modes corresponding to sensing regions 504A, 504D and 504E as shown in FIG. 14B-D. Explained further, if performance measure E is chosen according to example 2 above, requiring that each target be covered at least one time, then the algorithm will not find it necessary to include beam-patterns corresponding to positions 504B and 504C of sensor 502 in FIG. 13 to provide coverage to all the targets.

Thus the algorithm not only determines the placement site and orientations of sensor 302 and 502, but also their switching sequence in accordance with the performance measure. Depending on the application, after the positions shown in FIG. 14D, the switching sequence of sensors may return to their positions shown in FIG. 14B and then repeat the cycle. Obviously, in the case of sensor 302 the algorithm has picked both the modes that light up its four sensing regions, two at a time, as shown. Thus, a switching sequence of the various modes of sensors 302 and 502 as determined by Modified Greedy Algorithm 2 in the solution illustrated in FIG. 14B-D can be (302A, 302C, 504A), (302B, 302D, 504E), (302A, 302C, 504D), (302B, 302D, 504A), (302A, 302C, 504E), (302B, 302D, 504D), (302A, 302C, 504A), . . . and then repeating this sequence. In summary, the algorithms of the present invention determine not only the placement and orientation/configuration of the deployed sensors but also their switching sequences that ultimately govern their modes of operation. It is also worth recalling that there is an implicit assumption of the presence of obstructions/obstacles as defined earlier, in the various embodiments described in this disclosure, which would affect the sensing/visibility regions of the various sensors in the embodiments, and these obstructions/obstacles are often omitted from drawings and explanation for convenience.

As stated before, the coverage can be according to a given performance measure as required according to the needs of the application at hand. Even though the embodiment shown in FIG. 14A-D switches the modes of sensors 302 and 502 synchronously, i.e. at the same points in time of the switching cycle, there is no such requirement of synchronous switching of the various modes of the sensors according to the principles of the invention. One skilled in the art will readily recognize that in an asynchronous operation of the sensors, their modes and corresponding sensing regions will switch independently of one another and the algorithms presented thus far will ensure that the target sites are covered according to the chosen performance measure.

In an interesting set of applications of the multi-modal sensor deployment systems of the instant invention, the sensing stations are people or other living beings who perceive reality in various modes. For example, if a security guard is responsible for looking out of north window and south window of a sentry tower, that corresponds to his two modes of monitoring. The targets in such examples could be geographical terrain or areas to be monitored, even other objects or living beings. Other related embodiments can use a camera or other sensors for monitoring rather than a living being. In other similar applications, the sensing station can be a content-provider, while the targets can be users, and the modes of operation can be various types of contents to be delivered to various types of users according to some matching criteria, based potentially on users' profiles, habits and usage patterns, among other things.

It will be apparent to those skilled in the art the understanding of the notations in this disclosure, and how to implement or code the above Modified Greedy Algorithms 1 and 2, using the specific software programming techniques, data structures and software libraries that are commonly available. Such software design and engineering details are well understood by skilled artisans. The reader is further advised that the solution offered by Modified Greedy Algorithms 1 and 2 above is not necessarily unique in the sense that more than one solutions may exist that offer the same near-optimal deployment of available sensing stations for providing coverage according to a given performance measure.

So the solution derived by the variation of Greedy algorithm as taught by the instant invention, may produce a result that is not the most optimal solution, but rather a near-optimal solution, by up to a log factor. Consequently, it may be possible to have a more optimal solution that comprises less sensing stations, or has more optimal placement and switching of sensing stations, than the solution computed by the above algorithms. Finally, also note that the Greedy algorithm by its nature is sensitive to the initial choice of mode (or effective-mode) in the switching sequence, during its programmatic iterations, and also to the discretization or sampling of the workspace. It is therefore possible, that given a different initialization of target sets or a different discretization or sampling of the workspace, the same Greedy algorithm may produce a better result i.e. use less number of sensors or more optimal deployment of sensors compared to the other choice of the initialization or sampling.

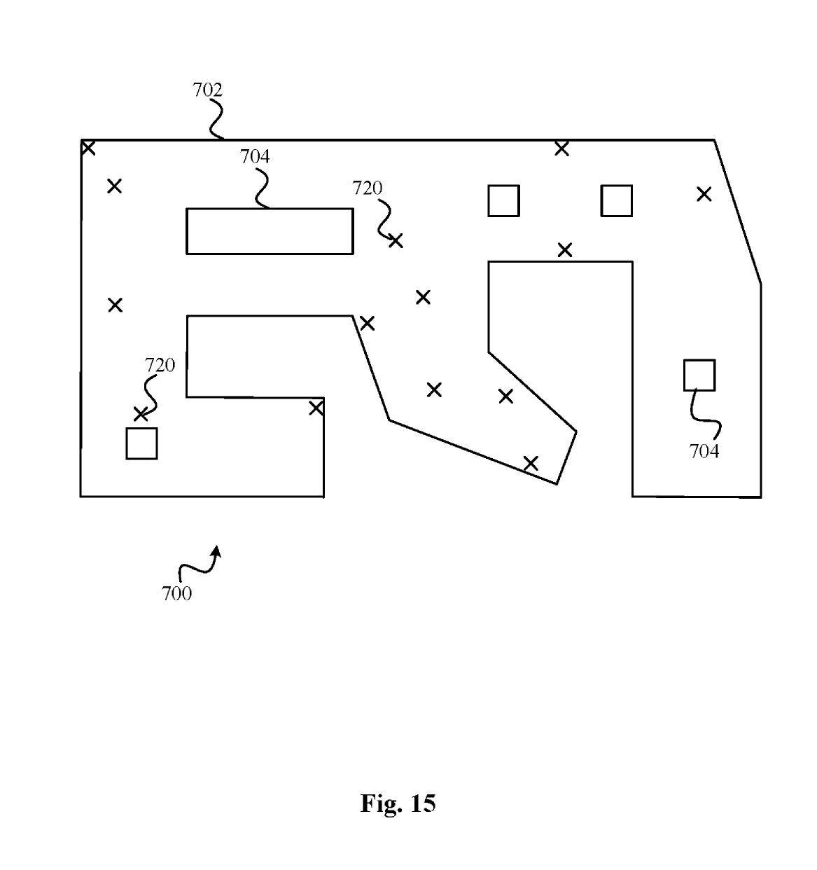

In computational geometry, a sampling is an arrangement of points in the space chosen randomly, pseudo-randomly, along a regular grid, etc. Indeed through sampling a geometric problem is easily converted into a finite set system. Very often it is desired to discretely sample a workspace such that there are a finite number of discrete points that comprise candidate sites {p₁, p₂, . . . , pₘ} and ground set X. It is possible for placement sites determined by the instant invention to either overlap with the one or more target/ground set ‘X’es, or not, under the teachings of the invention. In other words, it is entirely possible for placement sites to be chosen so that they allow the sensors to ‘look into’ the workspace and provide coverage while themselves remaining outside. Alternatively, it is also possible for placement sites to be coming led with the target sites. FIG. 15 represents workspace 702 that has been discretely sampled into a handful of points represented by ‘X’es in FIG. 15. Note also in FIG. 15 that for clarity we have only used reference numeral 720 to indicate two such sampled points or ‘X’es. Thus in the embodiments of the invention that utilizes a sampled workspace, it will be only required to observe points 720 marked by ‘X’es in workspace 702 as shown in FIG. 15, by the computed placement sites, rather than the entirety of the interior of workspace 702 (excluding obstructions).

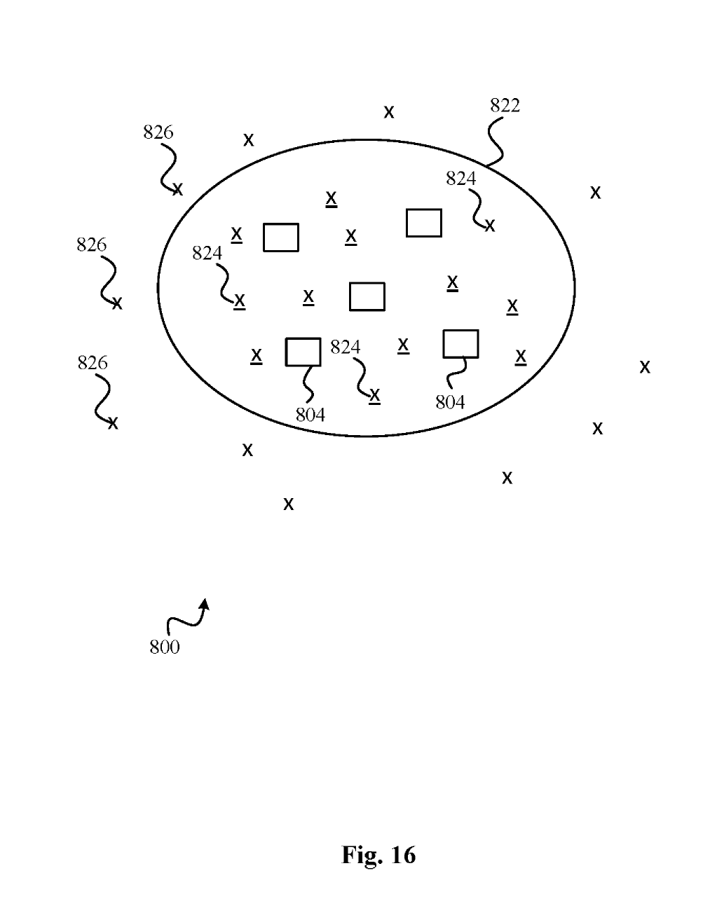

As stated above, that in some embodiments, candidate sites {p₁, p₂, . . . , pₘ} and ground set X are overlapping, that is, a candidate site can also be a target site or vice versa. However, in an alternative embodiment of the invention, candidate sites and target sites do not overlap. Such a situation is expected when there is a set of locations, such as walls or ceilings for sensing stations, and there are points or locations of interest on the floor or other parts of the building that are required to be observed. FIG. 16 represents such a scenario where oval shape 822 represents a region of interest 822 containing target sites 824 whilst candidate sites 826 exist outside of region of interest 822 and are non-overlapping with target sites 824. Note again, that for clarity we have labeled only three candidate sites by reference numeral 826 indicated by crosses ‘X’ (not underlined), and only three target sites by reference numeral 824 indicated by ‘X’ (underlined).

In variations of the embodiment explained earlier the invention supports added constraint that placement sites for a certain type of sensor can only be chosen from a set of sampled points or a placement region and that only a certain quantity of certain types of sensors are available. Such constraints are commonplace in real environments where cameras and other sensors are available in limited quantity and they can only be placed at appropriate locations in a workspace, such as walls and ceilings of a certain height, shape, construction, etc. Now we will look at the changes or variations to the Greedy algorithm presented above, that are required to enable this embodiment having constraints on the placement and quantities of sensors. Note that in as far as the constraint requiring the placement of the sensing stations at predetermined locations or placement regions, this constraint is easily satisfied by the selection of candidate sites {p₁, p₂, . . . , pₘ} in the first place. In other words, the algorithms of the invention will only pick candidate sites that satisfy the placement constraints of the problem

As far as satisfying the constraint of predetermined quantities of various types of sensors, the Greedy algorithm above can be modified to include a ‘tally’ for each type of sensor. During each iteration of the algorithm shown, the algorithm will first check if the tally for the corresponding sensor is greater than zero. Once it picks the sensor and mode that maximizes the constraint in step 30 of the Modified Greedy Algorithms 1 and 2 above, it will also decrement the tally of the corresponding sensor. If the tally reaches zero, the algorithm will stop choosing that sensor in subsequent iterations. Once all tallies have reached zero, the algorithm will terminate, whether or not the respective performance measure has been satisfied. Note that this will be a best-effort solution by the modified Greedy algorithms presented earlier. Such a best-effort algorithm will not guarantee that the computed solution will cover all target sites in all target sets ‘X’es, and may only provide a partial cover.

As taught above, preferably the solution that forms the basis of the multi-modal sensor deployment strategy of the present invention is based on the familiar Greedy algorithm. In the preferred embodiment, the solution determined by the present invention is found in polynomial time. Those skilled in the art will know that Greedy algorithm gives an approximation ratio that is bounded by (1+log R_{L}), where approximation ratio is defined as the size of the computed cover C divided by size of the optimal cover C* i.e. |C|/|C*|, and R_{L} is the set with the largest cardinality in the maximization step 30 of Greedy Algorithms 1 and 2 above.

Recall from earlier teachings that a composite sensing/visibility region v(p), or simply sensing region v(p), of a sensing station at a site p is a collection of up to k sensing regions corresponding to various sensors present on the sensing station. For a multi-modal sensing station having r modes, there can be r sensing regions v(p,1),v(p,2) . . . v(p,r), each corresponding to a given mode md=1 . . . r of the operation of the sensing station, and each sensing region v(p,1),v(p,2) . . . v(p,r) may itself be a collection or some combination of up to k sensing regions of k sensors present in the multi-modal sensing station. Furthermore, a composite multi-modal sensing region v^{r}(p) is the collection of its r sensing regions v(p,1),v(p,2) . . . v(p,r) corresponding to modes md=1 . . . r. Each mode md may have its associated parameters params(md) characterizing/parameterizing its operation, thus defining an effective-mode as the combination of mode md and its associated parameters params(md) i.e. (md,params(md)). Oftentimes for convenience, while referring to an effective-mode, we may simply refer to it simply as mode md, with the understanding of the implicit presence of its parameters params(md).

The collection of individual sensing regions vₖ(p) is preferably a union, to form the resultant composite sensing region v(p) i.e. v(p,md)=Uᵥ_{ₖ}₍ₚ₎. The collection of individual sensing regions vₖ(p) can preferably be an intersection of the individual sensing regions vₖ(p) to form the resultant composite sensing region v(p,md), i.e. v(p,md)=∩ᵥ_{ₖ}₍ₚ₎. Still preferably, the collection of individual sensing regions vₖ(p) is a generic set operation or an alternative mathematical operation of the individual sensing regions vₖ(p,md) to form the resultant composite sensing region v(p,md). Also, not all of k sensing regions need to be utilized to form the resultant composite region v(p,md) for a given mode. As an example, v(p,modeA)=∩ᵥ_{ₖ₋₂}₍ₚ₎ while v(p,modeB)=∪ᵥ_{ₖ₋₁}₍ₚ₎, and v(p,modeC)= [symbol] ᵥ_{ₖ₋₄}₍ₚ₎, signifying that only k−2 sensing regions are being utilized in modeA, only k−1 sensing regions in modeB, and only k−4 regions are being utilized in modeC respectively, and that modeA and modeB utilize different set operations while modeC utilizes a generic mathematical operation [symbol] that may be chosen as appropriate to fit the needs of an application. To be complete, note that the above collection may only consist of one sensing region, if there is only sensor on the sensing station.

In a highly preferred embodiment of the present invention, target sites are not merely locations or points, but sensed stations or smart sensors, with their own sensed regions analogous to sensing regions of sensing stations taught above. This unique capability of the present invention, allows the sensor deployment as taught above to be applied to a variety of interesting applications in a number of industry verticals that have requirements to observe and detect not just passive parts of a geography or ‘locations’ of interest, but rather monitor active devices with their own smart transmission capabilities and their own unique configurations, characteristics and radiation patterns.

Thus, each sensed station also has one or more sensed regions around it, likely but not necessarily, as a result of the individual sensors present on the sensed station. A sensed region of a sensed station at a target site is defined as the set of all sites around that sensed station that if overlapping with the sensing region of a sensing station at a candidate site will result in that sensed station being sensed or communicated with, by that sensing station. Preferably, the sensing region of a sensing station at a candidate site and a sensed region of a sensed station at a target site are defined such that the sensing station can sense or communicate with the sensed station only if the sensed station is in the sensing region of the sensing station and the sensing station is in the sensed region of the sensed station.

Preferably, the sensed region is further constrained by a sensed range and a sensed orientation of the sensed station. Preferably, there is a composite sensed region around each sensed station that is a collection of the individual sensed regions around the sensed station. In a related embodiment, the collection of individual sensed regions of a sensed station, called the composite sensed region, is taken to be a union of the individual sensed regions. Alternatively, the composite sensed region is taken to be an intersection of the individual sensed regions. Still in another embodiment, the composite sensed region is taken to be based on a generic set operation of the individual sensed regions of the sensed station.

Recall the earlier definition of a sensing region vₖ(p) around a sensing station at a candidate site p as the region in which the sensing station can perform the action of sensing, or simply sense, a site or a sensed station. We will refer to such coverage as ‘sensing coverage’. A highly preferred set of embodiments of the invention expand the above capabilities of sensing coverage to include the ability to communicate and not just sense. Consequently we will refer to such coverage as ‘network coverage’. Obviously network coverage implies sensing coverage. In other words, communication implies sensing. Differently put, the performance of the act/action of communicating with another device such as a sensed station, indicates the knowledge of the presence or sensing, of that device or sensed station. Obviously, if the device or sensed station is not present, then a sensing station can still sense the site or location where the sensed station could have been, but not able to communicate or provide network coverage to that site.

Communication can take a number of different forms including but not limited to sending and receiving messages that may contain just ‘pings’ or data payload, sending and receiving different types of electromagnetic radiation patterns to mean different things, sending and receiving different types or strengths of electrical signals to mean different things, sending and receiving different types or strengths of audio signals to encode different meanings and varying any characteristic of a physical signal to encode messages, etc. Let us also address the expanded definition of a sensing region of the current invention under network coverage more precisely. To enable network coverage, sensing region of a sensing station at a given candidate site represents the collection of sites or locations in the workspace where the placement of a sensed station will enable the sensing station to communicate with that sensed station.

In the preferred embodiment of the invention the sensing stations and the sensed stations of the present invention are wireless devices that operate substantially in the 60 GHz range. Those skilled in the art will agree that 60 GHz frequency range is poised to become the next big frequency in the world of wireless devices, with both short-range and wider area applications. The frequency is part of the ‘V-Band’ frequencies in the United States and is considered among the millimeter radio wave (mmWave) bands. Its applications will include a broad range of new products and services, including high-speed, point-to-point wireless local area networks and broadband internet access. High Definition Wireless (WirelessHD) is another recent technology that operates substantially near the 60 GHz range. A key characteristic of this frequency range is that its highly directional, ‘pencil-beam’ signal characteristics permits different systems to operate close to one another without causing interference. The upcoming Wi-Fi standard IEEE 802.11ad is also slated to run in this frequency range.

Methods of the present invention further delineate the steps required to execute the sensor deployment strategy of the present invention taught above. The methods provide the steps for determining the placement sites from a set of candidate sites {p₁, p₂, . . . , Pₘ} for sensing stations by providing sensed stations that can be placed at target sites in the workspace, and providing at least one mode of operation of the sensing station, the mode established in accordance with a switching sequence. The methods further provide a target set associated with each stage of the switching sequence, the target set thus provided comprising of target sites. They further provide zero or more obstructions, and then provide one or more sensing regions around each sensing station corresponding to each mode, when the sensing station is at a candidate site p. A sensing region of the sensing station is a collection of all sites b such that the sensing station at candidate site p is able to sense the sensed station at site b, despite the provided obstructions. In related embodiments, the invention further extends the definition of sensing region beyond sensing coverage to include communication and hence provide network coverage. Consequently in such embodiments, the sensing region is defined as a collection of all sites b in the workspace such that the sensing station at candidate site p is able to communicate with a sensed station at site b, despite the provided obstructions.

The methods further provide the steps for computing coverage solution for the target sites in target sets, preferably based on a variation of the popular Greedy algorithm, such that each target site in each target set is covered according to some performance measure. The performance measure can preferably be a measure of the time of coverage, or it can be any other measure so chosen to satisfy the needs of a given application. The solution thus computed is a near-optimal solution and can be computed using any suitable algorithm appropriate for the application at hand, including the custom variations of the Greedy algorithm disclosed in the invention. It should be noted that the invention is not restrictive of a particular algorithm for the computation of the coverage solution, and while several embodiments are taught in this specification, other variations, ways and algorithms to practice the instant invention are entirely possible, within the scope of this disclosure.

In view of the above teaching, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A system of determining a set of placement sites from a set of candidate sites for at least one sensing station, comprising:
a) zero or more obstructions;
b) a mode of said at least one sensing station;
c) said mode established in accordance with a switching sequence;
d) a target set associated with each stage of said switching sequence, said target set comprising zero or more target sites;
e) at least one sensing region around each said at least one sensing station, where a site b is in said at least one sensing region if said at least one sensing station is able to perform an action selected from the group consisting of, sense said site b and communicate with a sensed station at said site b, notwithstanding said obstructions;
wherein said set of placement sites is chosen from said set of candidate sites such that said target sites are covered as determined by a performance measure.

2. The system of claim 1, wherein said switching sequence is predetermined.

3. The system of claim 1, wherein said switching sequence is determined in accordance with said chosen set of placement sites.

4. The system of claim 1, wherein said performance measure is a measure of time.

5. The system of claim 1, wherein said mode affects one or more beam-patterns of said at least one sensing station, said one or more beam-patterns further affecting its said at least one sensing region.

6. The system of claim 1, wherein said mode is governed by one or more parameters.

7. The system of claim 6, wherein said one or more parameters are selected from the group consisting of field-strength, heading, geometry, gain, signal-phase, input-power, frequency, phase-noise and impedance.

8. The system of claim 1, wherein said mode in each of said at least one sensing station is established synchronously in accordance with said switching sequence.

9. The system of claim 8, wherein at each said stage of said switching sequence, said mode is identical in each of said at least one sensing station.

10. The system of claim 8, wherein at each said stage of said switching sequence, one or more parameters of said mode amongst a plurality of said at least one sensing station, are allowed to differ.

11. The system of claim 1, further comprising at least one sensed station, each said at least one sensed station able to be placed at one of said target sites.

12. The system of claim 11, wherein said at least one sensed station merely represents the location of its corresponding target site.

13. The system of claim 1, further comprising a sensing range and a sensing orientation of said at least one sensing station constraining its said at least one sensing region.

14. The system of claim 1, further comprising a composite sensing region of said at least one sensing station, as a collection of two or more said at least one sensing region.

15. The system of claim 14, wherein said collection is selected from the group consisting of a union, an intersection, a set operation, and a mathematical operation of said two or more said at least one sensing region.

16. The system of claim 1 further operating in a workspace, said workspace selected from the group consisting of a continuous workspace and a discretized workspace.

17. The system of claim 16, wherein the union of said target sites represents the entirety of said workspace.

18. The system of claim 1, wherein each said candidate site further comprises the n-dimensional coordinates of the location of said candidate site and said sensing orientation in n-dimensions of said at least one sensing station at said location, where n is a whole number greater than 1.

19. The system of claim 1, wherein each said candidate site further comprises the n-dimensional coordinates of the location of said candidate site, and said sensing orientation in n-dimensions of said at least one sensing station at said location, is unconstrained.

20. The system of claim 1, wherein there is a predetermined number of said at least one sensing station.

21. The system of claim 1, wherein the locations of said placement sites in said workspace can only be chosen from a predetermined set of locations.

22. The system of claim 1, wherein the locations of said placement sites in said workspace can only exist in one or more predetermined regions.

23. The system of claim 1, wherein said candidate sites are selected from the group consisting of overlapping with said target sites and non-overlapping with said target sites.

24. The system of claim 1, wherein said set of placement sites is chosen utilizing a Greedy algorithm solution.

25. The system of claim 1, wherein said set of placement sites is derived utilizing a polynomial-time solution.

26. The system of claim 1, wherein said at least one sensing station comprises a wireless sensor operating substantially at a frequency of 60 GHz.

27. The system of claim 1, wherein said at least one sensing station comprises a camera.

28. The system of claim 1, wherein said at least one sensing station is selected from the group consisting of living beings and objects, and said candidate sites and said target sites comprise geo-location coordinates.

29. A method of determining a set of placement sites from a set of candidate sites for a sensing station, comprising the steps of:
a) providing zero or more obstructions;
b) providing a mode of said sensing station;
c) providing said mode to be established in accordance with a switching sequence;
d) providing zero or more target sites;
e) providing a sensing region around said sensing station, and providing said sensing region to consist of every site b such that said sensing station is able to perform an action selected from the group consisting of, sense said site b and communicate with a sensed station placed at said site b, notwithstanding said obstructions; and
choosing said set of placement sites from said set of candidate sites such that said target sites are covered as determined by a performance measure.

30. The method of claim 29, wherein said switching sequence is predetermined.

31. The method of claim 29, wherein said switching sequence is determined in accordance with said choosing of said set of placement sites.

32. The method of claim 29 further providing a composite sensing region v(p,md) corresponding to said mode and of said sensing station placed at a candidate site p, to be a collection of a plurality of said sensing region.

33. The method of claim 29 further choosing said placement sites utilizing the steps of:
a) Defining a set T of time instants t=1, 2 . . . T, and a target set Xₜ at each of said time instants t such that each said target set Xₜ comprises zero or more said target sites;
b) Initializing: (i) a set P equal to said set of candidate sites, and (ii) a set S of said placements sites to an empty set;
c) Selecting a candidate site sεP with the most number of said target sites in a collection of at least one of said sensing region, in all said time instants t altogether;
d) Deleting said target sites in said collection at each of said time instants t, from corresponding said target set Xₜ;
e) Deleting said candidate site s from said set P;
f) Adding said candidate site s to said set S; and
g) Repeating steps (c) through (f) above in accordance with said performance measure.

34. The method of claim 33, wherein said performance measure requires each of said target sites to be covered at least one of said time instants t.

35. The method of claim 33, wherein said performance measure requires each of said target sites to be covered at least a fraction of the sum of all of said time instants t.

36. The method of claim 33, wherein said performance measure requires at most a predetermined fraction of said target sites to be uncovered at any of said time instants t.

37. The method of claim 33, wherein said performance measure requires each of said target sites to be covered at all of said time instants t.
